(19) United States
(12) Patent Application Publication
(10) Pub. No.: US 2023/0067687 A1
(43) Pub. Date: Mar. 2, 2023

(54) SYSTEM AND METHOD AND APPARATUS FOR INTEGRATING CONVERSATIONAL SIGNALS INTO A DIALOG

(71) Applicant: Cogito Corporation, Boston, MA (US)

(72) Inventor: Ali Azarbayejani, Boston, MA (US)

(73) Assignee: Cogito Corporation, Boston, MA (US)

(21) Appl. No.: 17/900,037

(22) Filed: Aug. 31, 2022

Related U.S. Application Data
(60) Provisional application No. 63/239,206, filed on Aug. 31, 2021.

(51) Int. Cl. G10L 15/22; H04M 3/51; G10L 25/63; G10L 15/18; G10L 15/02; G06Q 30/00

(52) U.S. Cl. CPC G10L 15/22; H04M 3/5183; G10L 25/63; G10L 15/18; G10L 15/02; G06Q 30/01; H04M 2201/40; G10L 2015/225

(57) ABSTRACT

Integrating behavioral and lexical analysis of conversational audio signals with CRM (Customer Relationship Management) workflow analysis signals to provide real-time guidance to agents who are both speaking with a customer telephonically and interacting with the customer's information using a CRM system. This includes intaking audio and CRM analysis signals in real-time, extracting the behavioral and lexical signals from the audio. The CRM, behavioral, and lexical information are combined to produce guidance and scoring signals, which are output to the CRM in real-time to facilitate real-time guidance and scoring. The data can be stored for future reference.

### CROSS REFERENCE TO RELATED APPLICATIONS

The present application claims the benefit of U.S. Provisional Patent Application No. 63/239,206 filed Aug. 31, 2021, entitled “System and Method for Integrating Conversational Signals into Customer Relationship Management”, the entire disclosure of which is hereby incorporated herein by reference.

### FIELD OF THE DISCLOSURE

The present disclosure generally relates to the integration of behavioral and lexical analysis of conversational audio signals into a dialog, such as a customer relationship management (CRM) system.

### BACKGROUND

Currently, existing CRM systems do not have access to real-time conversational data from audio data when providing guidance, for example, a “next best action,” to an agent. Existing real-time guidance systems do not have adequate access to CRM workflow data to make inferences for guidance and scoring a dialog between a customer and an agent. Furthermore, there is no current system or method that provides CRM systems with conversational guidance in real-time or that can integrate CRM data into the real-time conversational guidance or scoring. Thus, there is a need to provide, in real-time, conversational guidance to a CRM system that is based on behavioral and lexical analysis while incorporating the data from the CRM system.

### BRIEF SUMMARY OF THE DISCLOSURE

One embodiment is directed to a computer-implemented method for outputting feedback to a selected device. The method includes accessing behavioral and lexical features determined from audio data associated with a conversation between a first party and a second party. The method also includes accessing, from a customer relationship system management (CRM) system, customer relationship management (CRM) data that includes one or more of: input from the first party, management flow data associated with the conversation, or information about the second party. Further the method includes applying the behavioral and lexical features and the CRM data to one or models that classify aspects of the conversation. The method also includes receiving, from the one or more models, one or more of guidance data or scoring data determined based at least partially on the behavioral and lexical features and the CRM data. The guidance data includes guidance for the first party in the conversation with the second party, and the scoring data includes a rating of the conversation. The method includes outputting, to the CRM system, a notification comprising the one or more of guidance data or scoring data in a format associated with the CRM system.

Another embodiment is directed to a method, wherein the one or more models comprise a behavioral model, a context model, a call type model, a topic detection model, and a call score model.

Another embodiment is directed to a method, wherein the one or more models are updated based on the behavioral and lexical features and the CRM data.

Another embodiment is directed to a method, wherein the notification comprises one or more suggestions for interacting with the second party.

Another embodiment is directed to a method further comprising determining the behavioral and lexical features from the audio data.

Another embodiment is directed to a method, wherein determining the behavioral and lexical features comprises: identifying one or more parameters of the audio data; and utilizing the one or more parameters during the determination.

Another embodiment is directed to a method, wherein the one or more parameters include indicators of an emotional state of the second party.

Another embodiment is directed to a method, wherein the notification comprises a rating of the performance of the first party during the conversation.

Another embodiment is directed to a method, wherein the notification comprises an alteration of a process flow of the CRM system.

Another embodiment is directed to a method, wherein the one or more of guidance data or scoring data is utilized by the CRM system during the conversation to affect the conversation.

Another embodiment is directed to a method, wherein the one or more of guidance data or scoring data is utilized by the CRM system to affect a subsequent communication session.

Another embodiment is directed to a system for outputting feedback data to a selected device. The system includes a memory configured to store representations of data in an electronic form; and a processor, operatively coupled to the memory, the processor configured to access the data and process the data to: access audio data; perform behavioral and lexical analysis on the audio data; extract features based on the behavioral and lexical analysis; apply machine learning on the extracted features; generate a notification based at least in part on the machine learning; determine whether the notification includes customer relationship management (CRM) data, wherein, upon determination that the notification includes CRM data, transmitting the notification to a CRM integration device; generate feedback data based, at least in part, on the transmission of the notification; and output the feedback data to a selected device.

Another embodiment is directed to the system, wherein, upon determination that the notification does not include CRM data, transmitting the notification to a guidance integration device.

Another embodiment is directed to the system, further comprising outputting the feedback data to the selected device during a communication session.

Another embodiment is directed to the system, further comprising identifying one or more parameters of the audio data; and utilizing one or more of the parameters during the performing behavioral and lexical analysis on the audio data.

Another embodiment is directed to the system, wherein the parameters include indicators of an emotional state of a caller.

Another embodiment is directed to the system, wherein the selected device is a supervisory device.

Another embodiment is directed to the system, wherein the audio data is obtained from a communication session between a caller and an agent.

Another embodiment is directed to a method for generating feedback. The method includes accessing audio data that includes behavioral information and lexical information; extracting the behavioral information and lexical information from the audio data; accessing CRM analysis signals in real-time; combining the CRM analysis signals, behavioral information, and lexical information to produce guidance and scoring signals; outputting the guidance and scoring signals to a user device to provide a user feedback related to a call session.

Another embodiment is directed to a method, wherein the guidance and scoring signals comprises guidance for interacting with a party to the call session.

### DESCRIPTION OF THE DRAWINGS

The foregoing summary, as well as the following detailed description of the exemplary embodiments of the disclosure will be better understood when read in conjunction with the appended drawings. For the purpose of illustrating the disclosure, there are shown in the drawings exemplary embodiments. It should be understood, however, that the disclosure is not limited to the precise arrangements and instrumentalities shown.

In the drawings:

FIGS. 1A and 1B illustrate a system for integrating conversational signals into a dialog.

FIG. 2 illustrates a process for model access according to an embodiment of the disclosure.

FIG. 3 illustrates a process for topic modeling according to an embodiment of the disclosure.

FIG. 4 illustrates a process for behavior modeling according to an embodiment of the disclosure.

FIG. 5 illustrates a process for context modeling according to an embodiment of the disclosure.

FIG. 6 illustrates a process for topic detecting according to an embodiment of the disclosure.

FIG. 7 illustrates a process for call scoring according to an embodiment of the disclosure.

FIG. 8 illustrates a process for guidance integration according to an embodiment of the disclosure.

FIG. 9 illustrates a process for CRM integration according to an embodiment of the disclosure.

FIG. 10 illustrates a process for data guidance according to an embodiment of the disclosure.

FIG. 11 illustrates a process for integrating conversational signals into a dialog according to an embodiment of the disclosure.

FIG. 12 illustrates another process for integrating conversational signals into a dialog according to an embodiment of the disclosure.

### DETAILED DESCRIPTION

Reference will now be made in detail to the various embodiments of the subject disclosure illustrated in the accompanying drawings. Wherever possible, the same or like reference numbers will be used throughout the drawings to refer to the same or like features. It should be noted that the drawings are in simplified form and are not necessarily drawn to precise scale. Certain terminology is used in the following description for convenience only and is not limiting. Directional terms such as top, bottom, left, right, above, below and diagonal, are used with respect to the accompanying drawings. The term “distal” shall mean away from the center of a body. The term “proximal” shall mean closer towards the center of a body and/or away from the “distal” end. The words “inwardly” and “outwardly” refer to directions toward and away from, respectively, the geometric center of the identified element and designated parts thereof. Such directional terms used in conjunction with the following description of the drawings should not be construed to limit the scope of the subject disclosure in any manner not explicitly set forth. Additionally, the term “a,” as used in the specification, means “at least one.” The terminology includes the words above specifically mentioned, derivatives thereof, and words of similar import.

“About” as used herein when referring to a measurable value such as an amount, a temporal duration, and the like, is meant to encompass variations of ±20%, ±10%, ±5%, ±1%, or ±0.1% from the specified value, as such variations are appropriate.

“Substantially” as used herein shall mean considerable in extent, largely but not wholly that which is specified, or an appropriate variation therefrom as is acceptable within the field of art. “Exemplary” as used herein shall mean serving as an example.

Throughout this disclosure, various aspects of the subject disclosure can be presented in a range format. It should be understood that the description in range format is merely for convenience and brevity and should not be construed as an inflexible limitation on the scope of the subject disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages, and characteristics of the exemplary embodiments of the subject disclosure may be combined in any suitable manner in one or more embodiments. One skilled in the relevant art will recognize, in light of the description herein, that the present disclosure can be practiced without one or more of the specific features or advantages of a particular exemplary embodiment. In other instances, additional features and advantages may be recognized in certain embodiments that may not be present in all exemplary embodiments of the subject disclosure.

Embodiments of the present disclosure will be described more thoroughly from now on regarding the accompanying drawings. Like numerals represent like elements throughout the several figures, and in which example embodiments are shown. However, embodiments of the claims may be embodied in many different forms and should not be construed as limited to the images set forth herein. The examples set forth herein are non-limiting examples and are merely examples, among other possible examples.

Embodiments of the present disclosure are directed to a platform that integrates analysis of dialog between two parties of a conversation with Customer Relationship Management workflow analysis. As a conversation occurs, the platform operates by obtaining dialog (e.g., audio data/signals, video data/signal, text data/signals, etc.) between the two parties (e.g., customer and agent) and by performing behavioral and lexical analysis on the dialog. The platform extracts behavioral and lexical data from the dialog to perform behavioral and lexical analysis on the dialog. To perform the behavioral and lexical analysis, the platform applies the behavioral and lexical data to one or more models. The models are trained to provide information on the current state of the conversation such as the emotional state of the parties, the topic of the conversation, the progress of the conversation, etc.

Concurrently, the platform can obtain CRM data and/or signals from a CRM system that is providing workflow guidance to a first party to the conversation (e.g., agent). The CRM data includes information about the first party (e.g., agent), such as identity, conversation history, performance reviews, etc., and information about the second party to the conversation (e.g., customer) such as identity. The CRM workflow data such as the current stage of a CRM workflow, CRM workflow instructions, etc. Then, the platform utilizes the results of the behavioral and lexical analysis and the CRM data to provide guidance and scoring data/signals back to the CRM system. For example, the guidance and scoring data/signals include a course of action to take by the first party (e.g., agent) such as suggested conservational dialog, offers to settle issues, a new stage of the workflow to begin, suggestions of parties to add to the conversation, etc. In another example, the guidance and scoring data/signals can include performance details or ratings of the first party (e.g., agent) during the conversation.

By integrating conversational analysis and data from a CRM system, the platform provides, in real-time, guidance and scoring to users of a CRM system. Additionally, by utilizing both conversation data and CRM data, the platform provides comprehensive guidance to users of a CRM system. As such, a user of the CRM system can be presented with accurate and relevant input, in real-time, during a conversation.

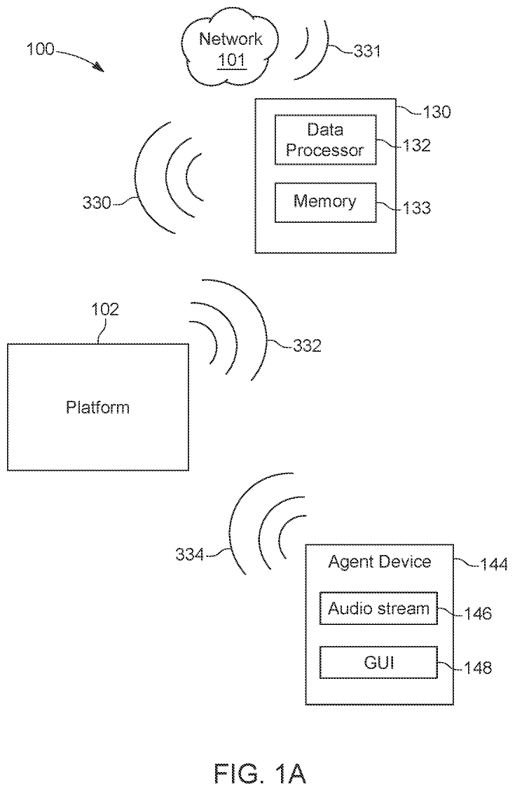

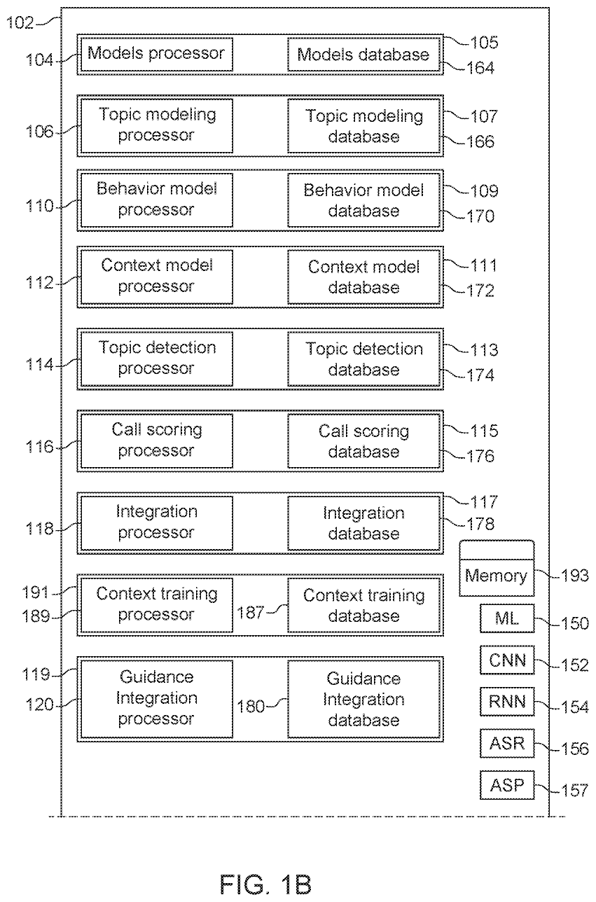

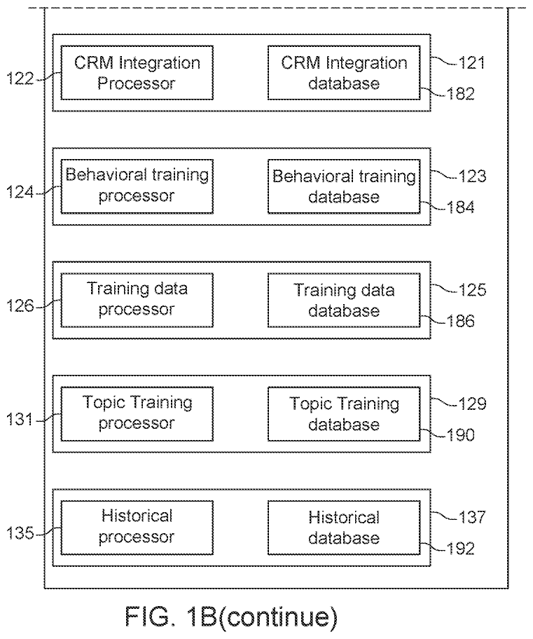

FIG. 1 is a system 100 for integrating conversational signals into dialogs, such as customer relationship management (CRM). While FIG. 1 illustrates various systems and components contained in the system 100, FIG. 1 illustrates one example of a system 100 of the present disclosure, and additional components can be added and existing systems and components can be removed.

CRM is a process in which a business or other organization administers interactions with customers, typically using data analysis to study large amounts of information. As described herein, CRM is a tool designed to help organizations offer their customers a unique and seamless experience, as well as build better relationships by providing a complete picture of all customer interactions, keeping track of sales, organizing, and prioritizing opportunities, and facilitating collaboration between various teams in an organization.

The system 100 includes one or more networks 101, platform 102, agent device 144, and a customer relationship management device, shown as CRM platform 130. The agent device 144, the platform 102, and the CRM platform 130 can communicate via the network 101. The network 101 can include one or more wireless or wired channels 330, 331, 332, and 333 that allow computing devices to transmit and/or receive data/voice/image signals. For example, the CRM platform 130 can communicate with computing devices using the wireless or wired channel 330 to transmit and/or receive data/voice/image signals to other devices. The agent device 144 can communicate with computing devices using the wireless or wired channel 334 to transmit and/or receive data/voice/image signals to other devices. The platform 102 can communicate with computing devices using the wireless or wired channel 332 to transmit and/or receive data/voice/image signals to other devices. One or more other computer devices (not shown), e.g., one or more customer devices, can communicate with the agent device 144, the platform, 102, and the CRM platform 130 using the communication channel 331.

The network 101 can be a communication network (e.g., wireless communication network, wired communications network, and combinations thereof), such as the Internet, or any other interconnected computing devices, and may be implemented using communication techniques such as Visible Light Communication (VLC), Worldwide Interoperability for Microwave Access (WiMAX), Long Term Evolution (LTE), Wireless Local Area Network (WLAN), Infrared (IR) communication; Public Switched Telephone Network (PSTN), radio waves, and other suitable communication techniques. The network 101 can allow ubiquitous access to shared pools of configurable system resources and higher-level services (e.g., cloud computing service) that can be rapidly provisioned with minimal management effort, often over the Internet, and rely on sharing resources to achieve coherence economies of scale, like a public utility. Alternatively, third-party cloud computing services (e.g., AMAZON AWS) enable organizations to focus on their core businesses instead of expending resources on computer infrastructure and maintenance.

The network 101 permits bi-directional communication between the platform 102, the agent device 144, the CRM device 130, and one or more other computer device (not shown), e.g., one or more customer devices. The network 101 can include a global system of interconnected computer networks that uses the Internet protocol (TCP/IP) to communicate between networks and devices. The network 101 can be a network of networks that may include one or more of private, public, academic, business, and government networks of local to global scope, linked by a broad array of electronic, wireless, optical networking, or other suitable wired of wireless networking technologies. The network 101 can carry a vast range of information resources and services, such as inter-linked hypertext documents, applications, e-mail, file sharing, and www web browsing capabilities.

The platform 102 can include one or more computing devices configured to perform the processes and methods described herein. The platform 102 can include one or more computing devices that include one or more processors and one or more memory devices that cooperate. The processor portion may include a CPU (central processing unit), an integrated electronic circuit that performs operations to achieve a programmed task, and other instructions that may be accessed, or retrieved, from an operating system and executed. The memory portion may include electronic storage registers, ROM, RAM, EEPROM, non-transitory electronic storage medium, volatile memory or non-volatile electronic storage media, and/or other suitable computer memory. The platform 102 can include software programs and applications (e.g., operating systems, networking software, etc. to perform the processes and methods described herein.

Likewise, the platform 102 can include and/or be supported by one or more cloud computing services. As used herein, a “cloud” or “cloud computing service” can include a collection of computer resources that can be invoked to instantiate a virtual machine, application instance, process, data storage, or other resources for a limited or defined duration. The collection of resources supporting a cloud computing service can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In some embodiments, the platform 102 can include a model device 105, a topic modeling device 107, a behavior model device 109, a context model device 111, a topic detection device 113, a call scoring device 115, an integration device 117, a context training device 191, a guidance integration device 119, a CRM integration device 121, a behavioral training device 123, a training device 125, a topic training device 129, a historical device 137, a machine learning device 150, a convolutional neural network device 152, a recurrent neural network device 154, an automatic speech recognition (ASR) 156, an acoustic signal processing (ASP) 157, and a general memory 193. While FIG. 1B illustrates the platform as including separate devices, one or more of the model device 105, the topic modeling device 107, the behavior model device 109, the context model device 111, the topic detection device 113, the call scoring device 115, the integration device 117, the context training device 191, the guidance integration device 119, the CRM integration device 121, the behavioral training device 123, the training device 125, the topic training device 129, the historical device 137, the machine learning device 150, the convolutional neural network device 152, the recurrent neural network device 154, the automatic speech recognition (ASR) 156, the acoustic signal processing (ASP) 157, and the general memory 193 can be incorporated into a single computing device and/or cloud computing service.

The platform 102 can be communicatively coupled with CRM networks or platforms 130 and/or agent device 144, via network 101, to provide or perform other services on the data (e.g., audio data) and transmit the processed data to another location, such as a remote device. The platform 102 processes (e.g., analyzes) received data (e.g., audio data, sensor, and usage data) by executing models, such as, inter alia, a models processor 104, guidance integration processor 120, and CRM integration processor 122.

One example of the components of platform 102 will now be described in more detail. While the example below describes various components contained in the platform 102, any of the components can be removed, additional components can be added, and the functionality of existing components can be combined. Additionally, while each device below is described as containing a processor and database, the functionality of one or more of the devices described below can be incorporated into a single computing device and/or cloud computing service.

The model device 105 can include a models processor 104 and a models database 164. The models processor 104 can include a CPU (central processing unit), an integrated electronic circuit that performs operations to achieve a programmed task, and other instructions that may be accessed, or retrieved, from an operating system and executed.

The models database 164 can be operatively coupled to the models processor 104. The models database 164 can include a memory, such as may include electronic storage registers, ROM, RAM, EEPROM, non-transitory electronic storage medium, volatile memory or non-volatile electronic storage media, and/or other suitable computer memory. A computer-readable storage medium may be, for example, but not limited to, an electronic, magnetic, optical, electromagnetic, infrared, or semiconductor system, apparatus, or device, or any suitable combination of the foregoing, including non-transitory computer-readable media.

More specific examples (a non-exhaustive list) of the computer-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray Disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals.

The models database 164 can be configured to store machine learning algorithms and is operatively coupled to the machine learning processor 150 resulting in the machine learning processor 150 executing the machine learning algorithms stored in model database 164. The model database 164 can incorporate the real-time audio stream, in which the machine learning models are continuously being refined and stored in the models database 164. The machine learning models stored in the models database 164 can be used in the process described in models processor 104, in which the real-time audio stream is applied to the various machine learning models stored in this database to provide real-time conversation guidance back to agent device 144.

The topic modeling device 107 can include a topic modeling processor 106 and a topic modeling database 166. The topic modeling processor 106 can include a CPU (central processing unit), an integrated electronic circuit that performs operations to achieve a programmed task, and other instructions that may be accessed, or retrieved, from an operating system and executed. The topic modeling processor 106 can be initiated when a predetermined time is reached, for example, at the end of the month, quarter, or year. Then, the topic modeling processor 106 can determine a time interval in which to collect data, such as from the previous month, week, etc.

The topic modeling database 166 can include a computer-readable storage medium may be, for example, but not limited to, an electronic, magnetic, optical, electromagnetic, infrared, or semiconductor system, apparatus, or device, or any suitable combination of the foregoing, including non-transitory computer-readable media, as described herein.

The topic modeling processor 106 can extract the call audio data from the determined time interval. For example, the call audio data from the previous day. In some embodiments, historical call audio data may be collected and stored in a historical database 192 on the platform 102. Then automatic speech recognition (ASR) is performed, via the ASR processor 156, on the call audio dataset from the determined time interval.

This dataset may be used as input to a topic modeling algorithm, which may be stored in the topic model database 166 and accessed by the topic modeling processor 106, for example, based on Latent Dirichlet Allocation, or LDA. Latent Dirichlet Allocation may be a generative statistical model that allows sets of observations to be explained by unobserved groups that explain why some parts of the data are similar. For example, suppose observations are words collected into documents. In that case, it posits that each document is a mixture of a small number of topics and that each word's presence is attributable to one of the document's topics. Using the definitions from the human annotators allows the algorithm to provide topic labels to each call utilizing the topic modeling processor 106.

The behavior model device 109 can include a behavioral model processor 110 and a behavior model database 170. The behavior model processor 110 can include a CPU (central processing unit), an integrated electronic circuit that performs operations to achieve a programmed task, and other instructions that may be accessed, or retrieved, from an operating system and executed.

The behavior model database 170 can include a computer-readable storage medium may be, for example, but not limited to, an electronic, magnetic, optical, electromagnetic, infrared, or semiconductor system, apparatus, or device, or any suitable combination of the foregoing, including non-transitory computer-readable media, as described herein.

The behavior model processor 110, in which ASP is used to compute features used as input to machine learning models (such models are developed offline and once developed, can make inferences in real-time). A variety of acoustic measurements are computed on moving windows/frames of the audio, using all audio channels. Acoustic measurements include pitch, energy, voice activity detection, speaking rate, turn-taking characteristics, and time-frequency spectral coefficients (e.g., Mel-frequency Cepstral Coefficients). These acoustic measurements are the inputs to the machine learning process, executed by the machine learning processor 150.

The context model device 111 can include a context model processor 112 and context model database 172. The context model processor 112 can include a CPU (central processing unit), an integrated electronic circuit that performs operations to achieve a programmed task, and other instructions that may be accessed, or retrieved, from an operating system and executed.

The context model database 172 can include a computer-readable storage medium may be, for example, but not limited to, an electronic, magnetic, optical, electromagnetic, infrared, or semiconductor system, apparatus, or device, or any suitable combination of the foregoing, including non-transitory computer-readable media, as described herein.

The context model processor 112, operating in conjunction with context model database 172, can be configured to detect “call phases,” such as the opening, information gathering, issue resolution, social, and closing parts of a conversation, which is done using lexical (word)-based features. As a result, all call audio is processed using the automatic speech recognition (ASR) device 156, capable of both batch and real-time/streaming processing. Individual words or tokens are converted from strings to numerical vectors using a pre-trained word-embeddings model developed internally or by using a publicly available one, such as Word2Vec or GloVE. These word embeddings are the features or inputs to the machine learning process for modeling call phases. The labeled data from the annotation process provides the targets for machine learning. The dataset of calls containing features and targets is split into training, validation, and test partitions. Supervised machine learning using neural networks is performed to optimize weights of a particular model architecture to map features to targets, with the minimum amount of error. A variety of stateful model architectures involving some recurrent neural network layers are used. After utilizing a large volume of model architectures and configurations, the best model is selected by evaluating accuracy metrics on the validation partition. The test partition is used simply for reporting final results to give an impression of how likely the model is to generalize well.

The topic detection device 113 can include a topic detection processor 114 and a topic detection database 174. The topic detection processor 113 can include a CPU (central processing unit), an integrated electronic circuit that performs operations to achieve a programmed task, and other instructions that may be accessed, or retrieved, from an operating system and executed.

The topic detection database 174 can include a computer-readable storage medium may be, for example, but not limited to, an electronic, magnetic, optical, electromagnetic, infrared, or semiconductor system, apparatus, or device, or any suitable combination of the foregoing, including non-transitory computer-readable media, as described herein.

The topic detection processor 114, operating in conjunction with the topic detection database 174, in which all labeled call audio is processed using ASR 156, can be capable of both batch and real-time/streaming processing. Individual words or tokens can be converted from strings to numerical vectors using a pre-trained word-embeddings model, either developed internally or by using a publicly available one such as Word2Vec GloVE. These word embeddings are the features or inputs to the machine learning process, using the machine learning processor 150, for modeling call phases. The labeled data from the annotation process provides the targets for machine learning. The labeled data from the annotation process, the data stored in the topic training database 190, operating with the topic training processor 131, can provide machine learning targets. The dataset of calls containing features and targets is split into training, validation, and test partitions. Supervised machine learning using neural networks, via the RNN 154 is performed to optimize weights of a particular model architecture to map features to targets, with the minimum amount of error. A variety of model architectures, including stateful, such as recurrent neural networks, or the RNNs 154, and stateless such as convolutional neural networks, or the CNNs 152, or a mix of the two are used depending on the nature of the particular behavioral guidance being targeted.

After utilizing a large volume of model architectures and configurations, the preferred model is selected by evaluating accuracy metrics on the validation partition. The test partition is used for reporting final results to give an impression of how likely the model is to generalize well.

The call scoring device 115 can include a call scoring processor 116 and a call scoring database 176. The call scoring processor 116 can be a CPU (central processing unit), an integrated electronic circuit that performs operations to achieve a programmed task, and other instructions that may be accessed, or retrieved, from an operating system and executed. The call scoring database 176 can include a computer-readable storage medium may be, for example, but not limited to, an electronic, magnetic, optical, electromagnetic, infrared, or semiconductor system, apparatus, or device, or any suitable combination of the foregoing, including non-transitory computer-readable media, as described herein.

The call scoring processor 116 can operate in conjunction with call scoring database 176, in which all labeled call audio is processed using ASR, and can be capable of both batch and real-time/streaming processing. Individual words or tokens are converted from strings to numerical vectors using a pre-trained word-embeddings model, either developed internally or by using a publicly available one such as Word2Vec GloVE. In addition to the ASR processing 156, the ASP processing 157 is also applied to the audio. It involves the computation of time-frequency spectral measurements (e.g., Mel-spectral coefficients or Mel-frequency cepstral coefficients). A preliminary, unsupervised machine learning process is carried out using a substantial unlabeled call center audio data volume. In some embodiments, this call center audio data may be stored in the training data database 186.

The machine learning training process involves grouping acoustic spectral measurements in the time interval of individual words (as detected by the ASR) and then mapping these spectral measurements, which are two-dimensional to a one-dimensional vector representation by maximizing the orthogonality of the output vector to the word-embeddings vector described above. This output may be referred to as “word-aligned, non-verbal embeddings.” The word embeddings are then concatenated with the “word-aligned, non-verbal embeddings” to produce the features or inputs to the machine learning process for modeling call scores. The labeled data from the annotation process provides the targets for machine learning. The dataset of calls containing features and targets is split into training, validation, and test partitions. Supervised machine learning using neural networks is performed to optimize weights of a particular model architecture to map features to targets, with the minimum amount of error. A variety of stateful model architectures involving some recurrent neural network layers are used. After utilizing a large volume of model architectures and configurations, the preferred model is selected by evaluating accuracy metrics on the validation partition. The test partition is used for reporting final results to give an impression of how likely the model is to generalize well.

The integration device 117 can include an integration processor 118 and an integration database 178. The integration processor 118 can be a CPU (central processing unit), an integrated electronic circuit that performs operations to achieve a programmed task, and other instructions that may be accessed, or retrieved, from an operating system and executed. The integration database 178 can include a computer-readable storage medium may be, for example, but not limited to, an electronic, magnetic, optical, electromagnetic, infrared, or semiconductor system, apparatus, or device, or any suitable combination of the foregoing, including non-transitory computer-readable media, as described herein.

The integration device 117 can be configured to operate in conjunction with the guidance integration processor 120, the guidance integration database 180, then CRM integration processor 122, and the CRM integration database 182. The integration device 117 can collect real-time guidance from the models database 164 and the topic model database 166, as well as connects to the CRM platform 130 and the data processor 132 to send the real-time guidance to CRM platform 130 through the guidance integration processor 120. Also, the integration device 117 can connect to the data processor 132 on the CRM platform 130 to receive data from the CRM platform 130 to be implemented into the models processor 104 and the models database 164 to create more refined or updated guidance that is based on the data provided by the CRM platform 130 which is then sent back to the data memory 133 on the CRM platform 130 through the integration processor 118 by the CRM integration processor 122.

The context training device 191 can include a context training processor 189 and a context training database 187. The context training processor 189 can be a CPU (central processing unit), an integrated electronic circuit that performs operations to achieve a programmed task, and other instructions that may be accessed, or retrieved, from an operating system and executed. The context training database 187 can include a computer-readable storage medium may be, for example, but not limited to, an electronic, magnetic, optical, electromagnetic, infrared, or semiconductor system, apparatus, or device, or any suitable combination of the foregoing, including non-transitory computer-readable media, as described herein.

The guidance integration device 119 can include a guidance integration processor 120 and a guidance integration database 180. The guidance integration processor 120 can be a CPU (central processing unit), an integrated electronic circuit that performs operations to achieve a programmed task, and other instructions that may be accessed, or retrieved, from an operating system and executed. The guidance integration database 180 can include a computer-readable storage medium may be, for example, but not limited to, an electronic, magnetic, optical, electromagnetic, infrared, or semiconductor system, apparatus, or device, or any suitable combination of the foregoing, including non-transitory computer-readable media, as described herein.

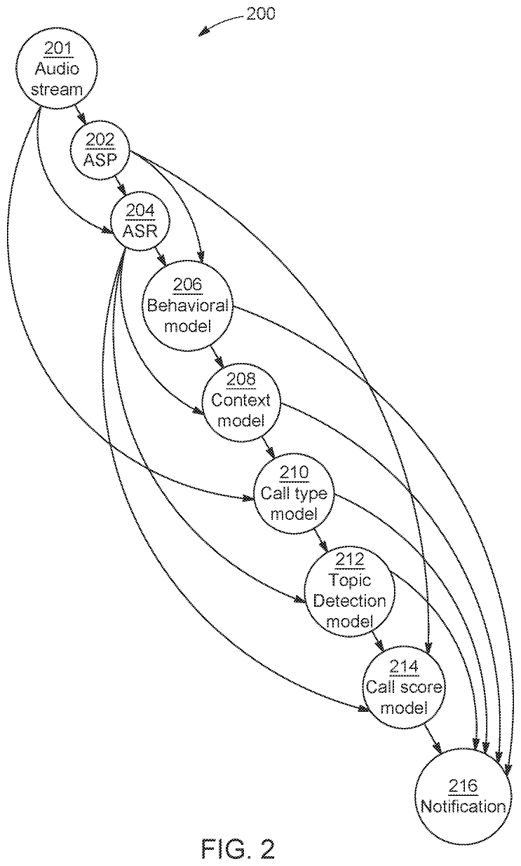

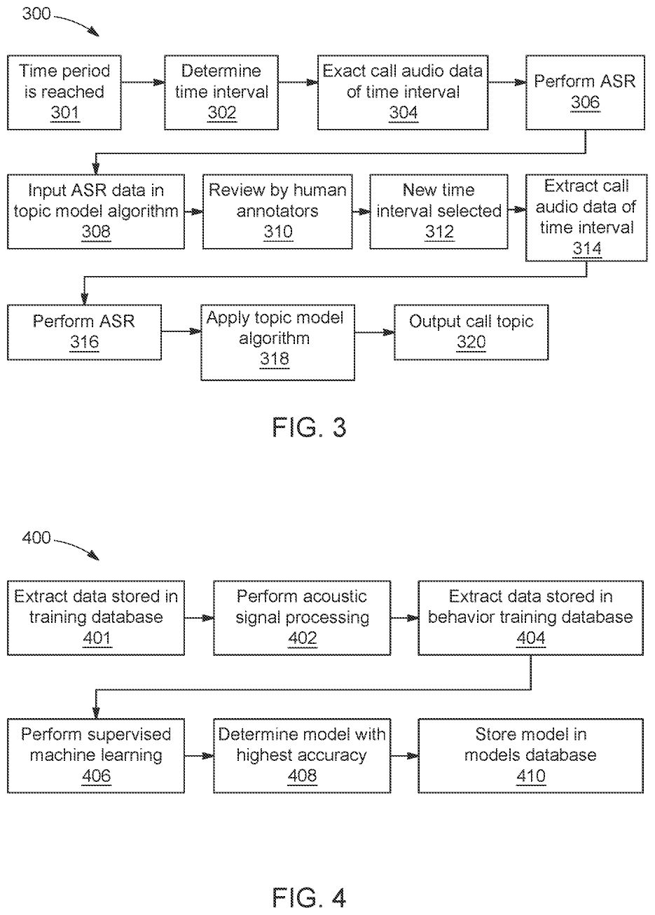

The guidance integration device 119 can be continuously polling for the notification (which is the result from the previously listed analysis) from the models processor 104 and may be stored in the models database 164 to be sent to the CRM platform 130, which is discussed herein with relation to FIG. 2 and FIG. 3. The second function of the integration processor 118 and the integration database 178 can be to incorporate the information from CRM platform 130 which is performed by the CRM integration processor 122 by collecting the CRM data and sending it to the models processor 104 and models database 164.

The guidance integration device 119, which connects to the CRM data processor 132, continuously polls for the guidance notification from the models processor 104 and sends the guidance notification to the CRM data processor 132. For example, the guidance sent to the CRM data processor 132 and/or CRM data memory 133 can be: the agent is slow to respond to a customer request; the call phase such as the opening, information gathering, issue resolution, social, or closing; the call type such as sales, IT support, billing, etc.; the call topic such as the customer requesting supervisor escalation, the customer is likely to churn, etc.; and/or the customer experience rating or customer satisfaction rating, etc.

The CRM integration device 121 can include an integration processor 122 and a CRM integration database 182. The CRM integration processor 122 can be a CPU (central processing unit), an integrated electronic circuit that performs operations to achieve a programmed task, and other instructions that may be accessed, or retrieved, from an operating system and executed. The CRM integration database 182 can include a computer-readable storage medium may be, for example, but not limited to, an electronic, magnetic, optical, electromagnetic, infrared, or semiconductor system, apparatus, or device, or any suitable combination of the foregoing, including non-transitory computer-readable media, as described herein.

The CRM integration processor 122, which connects to the CRM data processor 132, can send and receive the CRM data such as the information collected by the CRM platform 130, such as customer information, customer billing information, payment history, records of revenue from the customer, products currently used by the customer, products previously used by the customer, workflow strategies or procedures such as processes to resolve IT or technical issues, how the agent is supposed to collect customer information such as basic information, addresses, billing information, payment information, etc. For example, the CRM data may also be meta data collected by the CRM platform 130 such as what is currently being displayed on the agent's interface or display 148, such as a customer information screen or interface, payment screen or interface, etc., sends the CRM data to the models processor 104 and models database 164, and receives and sends a refined or updated guidance from the models processor 104 to the CRM data processor 132 and CRM data memory 133.

The behavioral training device 124 can include a behavioral training processor 124 and a behavioral training database 184. The behavioral training processor 124 can be a CPU (central processing unit), an integrated electronic circuit that performs operations to achieve a programmed task, and other instructions that may be accessed, or retrieved, from an operating system and executed. The behavioral training database 184 can include a computer-readable storage medium may be, for example, but not limited to, an electronic, magnetic, optical, electromagnetic, infrared, or semiconductor system, apparatus, or device, or any suitable combination of the foregoing, including non-transitory computer-readable media, as described herein.

The training device 125 can include a training data processor 126 and a training data database 186. The training data processor 126 can be a CPU (central processing unit), an integrated electronic circuit that performs operations to achieve a programmed task, and other instructions that may be accessed, or retrieved, from an operating system and executed. The training data database 186 can include a computer-readable storage medium may be, for example, but not limited to, an electronic, magnetic, optical, electromagnetic, infrared, or semiconductor system, apparatus, or device, or any suitable combination of the foregoing, including non-transitory computer-readable media, as described herein.

The topic training device 129 can include a topic training processor 131 and a topic training database 190. The topic training processor 131 can be a CPU (central processing unit), an integrated electronic circuit that performs operations to achieve a programmed task, and other instructions that may be accessed, or retrieved, from an operating system and executed. The topic training database 190 can include a computer-readable storage medium may be, for example, but not limited to, an electronic, magnetic, optical, electromagnetic, infrared, or semiconductor system, apparatus, or device, or any suitable combination of the foregoing, including non-transitory computer-readable media, as described herein.

The historical device 137 can include a historical processor 135 and a historical database 192. The historical processor 135 can be a CPU (central processing unit), an integrated electronic circuit that performs operations to achieve a programmed task, and other instructions that may be accessed, or retrieved, from an operating system and executed. The historical database 192 can include a computer-readable storage medium may be, for example, but not limited to, an electronic, magnetic, optical, electromagnetic, infrared, or semiconductor system, apparatus, or device, or any suitable combination of the foregoing, including non-transitory computer-readable media, as described herein.

The machine learning device 150 can a computing device with adequate processing power and memory capacity to apply artificial intelligence (Al) that helps Al systems learn and improve from experience. Indeed, successful machine learning training makes programs or Al solutions more useful by allowing the programs to complete the work faster and generate more accurate results. The process of machine learning works by forcing the system to run through its task over and over again, giving it access to larger data sets and allowing it to identify patterns in that data, all without being explicitly programmed to become “smarter.” As the algorithm gains access to larger and more complex sets of data, the number of samples for learning increases, and the system can discover new patterns that help it become more efficient and more effective. The first step for the machine learning model is to feed the model with a structured and large volume of data for training.

The convolutional neural network device 152 can include adequate processing power and memory to perform the neural network function and has a structure that includes a desired number of node layers, containing an input layer, one or more hidden layers, and an output layer. Each node, or artificial neuron, connects to another node or an artificial neuron and has an associated weight and threshold. If the output of any individual node is above the specified threshold value, that node is activated, sending data to the next layer of the network. Otherwise, no data is passed along to the next layer of the network. The neural network 152 relies on training data to learn and improve accuracy over time. The recurrent neural network device 154 can be any suitable model architecture, including stateful.

The use of the CNN 152 and the RNN 154 provides that after utilizing a large volume of model architectures and configurations, the preferred model is selected by evaluating accuracy metrics on the validation partition. The test partition is used simply for reporting final results to give an impression of how likely the model is to generalize well. Some post-processing can be applied to the machine learning model outputs running in production to power the notification-based user-interface effectively. The machine learning model output is typically a probability, so this is binarized by applying a threshold. Some additional post-processing can be applied to meet a certain duration of activity before the guidance notification is triggered or to specify the minimum or maximum duration of activity of the guidance notification. Supervised machine learning using neural networks may be performed to optimize weights of a particular model architecture to map features to targets, with the minimum amount of error. A variety of model architectures are used, including stateful, for example, recurrent neural networks, or the RNNs 154, and stateless, for example, convolutional neural networks, or the CNNs 152; in some embodiments, a mix of the two may be used, depending on the nature of the particular behavioral guidance being targeted.

The Automatic Speech Recognition device (ASR) 156 has adequate processing power and adequate storage to convert spoken words into text. The ASR 156 can detect spoken sounds and recognize them as words. The ASR 156 permits computers and processors to process natural language speech. The Acoustic Signal Processing device (ASP) 157 has adequate processing and memory to extract information from propagated signals.

The general memory 193 can include a computer-readable storage medium may be, for example, but not limited to, an electronic, magnetic, optical, electromagnetic, infrared, or semiconductor system, apparatus, or device, or any suitable combination of the foregoing, including non-transitory computer-readable media, as described herein.

One or more agent device(s) 144 (only one agent device 144 is shown, however; any suitable number of agent devices may be used), also referred to as user device(s), which may be an agent's terminal or a client's terminal, such as a caller's, terminal. An agent can operate an agent device 144 and be in communication with platform 102 via any combination of computers of network 101. Thus, an agent can be working at a workstation that is a user device, and a client, or caller, or customer, may be calling or communicating with an agent at an associated user device. The agent device 144 can be a laptop, smartphone, PC, tablet, or other electronic devices that can do one or more of receive, process, store, display and/or transmit data. The agent device 144 can have a connection, wired and/or wireless, to the network 101 and/or directly to other electronic devices. The agent device 144 can be a telephone that a caller, also referred to as a customer, or referred to as a client, uses to call a location. An agent may be stationed at that location and may communicate with the caller. Thus, the agent station may be more sophisticated with respect to functionality than the caller device, or the agent station may be a smartphone with a graphical user interface (GUI). The agent device 144 includes audio streamer 146 and a CRM graphical user interface (GUI) 148.

The audio streamer 146 can deliver real-time audio through a network connection, for example, a real-time audio stream of call audio between a call agent, who has access to the services provided by the platform 102, and a client or customer.

The CRM GUI 148, which may be a web application provided by the CRM platform 130, can be located on the agent device 144 in order to receive notifications, information, workflow data, strategies, customer data, or other types of data related to the customer or customer interaction that an agent may be having. The interface(s) may either allow inputs from users or provide outputs to the users or may perform both actions. For example, a user can interact with the interface(s) using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) may either be implemented as a Command Line Interface (CLI), a Graphical User Interface (GUI), a voice interface, or a web-based user-interface.

A CRM platform 130 which can be a third-party system that manages interactions, such as phone calls, with existing customers as well as past and future customers, that allows companies to manage and analyze its interactions with existing, past, and future customers that allows companies to improve business relationships with customers through improving customer retention as well as driving sales growth. While described as being a separate, third-party system, the CRM platform can be incorporated into, be a component of, or be associated with the platform 102.

The CRM platform 130 can include a CRM data processor 132 and a CRM data memory 133. CRM data processor 132 can be a CPU (central processing unit), an integrated electronic circuit that performs operations to achieve a programmed task, and other instructions that may be accessed, or retrieved, from an operating system and executed. The CRM data memory 133 can include a computer-readable storage medium may be, for example, but not limited to, an electronic, magnetic, optical, electromagnetic, infrared, or semiconductor system, apparatus, or device, or any suitable combination of the foregoing, including non-transitory computer-readable media, as described herein.

The CRM data processor 132 can connect to the integration processor 118 on the platform 102 to receive guidance on real-time interactions that agents are having with customers as well as sending data from the CRM platform 130, such as information regarding a customer, workflow data, etc., to the integration processor 118 to receive more refined or updated guidance based on the customer.

The CRM data processor 132 can connect to the guidance integration processor 120 and the CRM integration processor 122, receive a guidance notification from the guidance integration processor 120, and sends the guidance to the agent device CRM GUI 148. For example, the guidance notification may be the agent is slow to respond to a customer request; the call phase such as the opening, information gathering, issue resolution, social, or closing; the call type such as sales, IT support, billing, etc.; the call topic such as the customer requesting supervisor escalation, the customer is likely to churn, etc.; and/or the customer experience rating or customer satisfaction rating, etc. Then the data processor 132 connects to the CRM integration processor 122, receives a request for the CRM data, and sends the CRM data to the CRM integration processor 122, the CRM data may be customer information, customer billing information, payment history, records of revenue from the customer, products currently used by the customer, products previously used by the customer, workflow strategies or procedures such as processes to resolve IT or technical issues, how the agent is supposed to collect customer information such as basic information, addresses, billing information, payment information, etc. For example, the CRM data may also be meta data collected by the CRM platform 130 such as what is currently being displayed on the agent's interface or display, such as a customer information screen or interface, payment screen or interface, etc.

Then, the CRM data processor 132 is continuously polling for the updated guidance from the CRM integration processor 122 and receives the updated guidance and sends the updated guidance to the agent device CRM GUI 148, which may be the agent is slow to respond to a customer request; the call phase such as the opening, information gathering, issue resolution, social, or closing; the call type such as sales, IT support, billing, etc.; the call topic such as the customer requesting supervisor escalation, the customer is likely to churn, etc.; and/or the customer experience rating or customer satisfaction rating, etc., to the agent device CRM GUI 148 to provide the agent currently interacting with a customer more refined or updated guidance that is focused on the customer by incorporating the customer's CRM data, element 132.

In one embodiment, the platform 102 connects and receives the real-time audio stream, from audio streamer 146 and CRM data, from CRM GUI 148, initiates the acoustic signal processing (ASP) 157 and automatic speech recognition (ASR) 156 processes to extract the features or inputs for the machine learning models using machine learning processor 150 and applies the various machine learning models stored in the models database 164, which accesses or contains the machine learning models that are created in the behavior model processor 110, using data from memory 105. Other processors, such as context model processor 112, topic detection processor 114, and the call scoring processor 116, may process portions of the extracted features or inputs to create output notifications.

In some embodiments, a user of the platform 102 may determine a time interval, which may be in minutes, hours, days, or months. Alternatively, the time interval may be set apriori. Then the call audio data is extracted from the determined time interval. For example, the call audio data from the previous month. In some embodiments, the historical call audio data may be collected from agent device 144 and stored in the historical database 192 on the platform 102. Then automatic speech recognition 156 is performed on the call audio data from the determined time interval.

For example, call audio data received from a call session can be processed using automatic speech recognition (ASR) system 156, capable of both batch and real-time/streaming processing. Individual words or tokens may be converted from strings to numerical vectors using a pre-trained word-embeddings model, which may either be developed or by using a publicly available one such as Word2Vec GloVE. These word embeddings may be the features or inputs to the machine learning process, utilizing machine learning processor 150, for modeling call topics. Then the ASR data is inputted into a topic model algorithm, accessed from topic modeling database 166 and executed by topic modeling processor 106. For example, the text associated with each call is treated as a “document”. This dataset of documents can be used as input to the topic modeling algorithm, for example, based on Latent Dirichlet Allocation, or LDA. Latent Dirichlet Allocation may be a generative statistical model that allows sets of observations to be explained by unobserved groups that explain why some parts of the data are similar.

For example, observations may be words collected into documents. In such a case, each document is a mixture of a small number of topics, and each word's presence is attributable to one of the document's topics. Human annotators may then review the outputted topics by the topic model algorithm and stored in topic model database 166. The human annotators are given a small set of calls from the particular detected topic cluster of calls. They are asked to find a definition common to these examples from that cluster. A new time interval is then selected, for example, the call audio data from the previous day. In some embodiments, a user of the platform 102 may determine the time interval.

For example, call audio may be processed using an automatic speech recognition (ASR) system 156, capable of both batch and real-time/streaming processing. Individual words or tokens may be converted from strings to numerical vectors using a pre-trained word-embeddings model, which may either be developed or by using a publicly available one such as Word2Vec GloVE. These word embeddings may be the features or inputs to the machine learning process 150, 152, and 154 for modeling call topics. Then the pre-trained LDA topic model can be applied to the ASR data. For example, the text associated with each call is treated as a “document”.

The integration device 117 performs two functions, the first is to send the analysis performed by the platform 102 (behavioral analysis, call phase, call type, call score, topics, etc.) to the CRM platform 130. The second function of the integration device 117 is to incorporate the information from CRM platform 130, which is performed by the CRM integration processor 122 by collecting the CRM data and sending it to the models processor 104 and models database 164, (models device 105).

In one embodiment, models processor 104 may receive the real-time audio stream from the agent device audio streamer 146, receive the CRM data from the CRM integration processor 122, and initiates the ASP (157) and ASR (156) processes to extract the features or inputs for the machine learning models and applies the various machine learning models stored in the models database 164, which contains the machine learning models that are created in the behavior model processor 110, context model processor 112, topic detection processor 114, and the call scoring processor 116, to the extracted features or inputs to create the output notifications that are sent to the guidance integration processor 120 when the process does not include in the CRM data, however, if the process included the CRM data, then the notifications or guidance notifications are sent to the CRM integration processor 122.

A function of guidance integration device 119, is described by referring to FIG. 1 and FIG. 2. For example, in FIG. 2, element 200 an audio stream, which is discussed in the description, and step 216 (notification) sends the new results that incorporate the CRM data back to the CRM integration processor 122.

FIG. 2 shows a process for the models processor 104 according to an embodiment of the disclosure. The models processor 104 will now be explained with reference to FIG. 1 and FIG. 2. The process of FIG. 2 begins with the models processor 104 connecting to the agent device 144 to receive the audio stream 200 of audio data from the agent device 144, which may be a real-time audio stream of a call such as a current interaction with a user of the platform and a client such as an audio call. The models processor 104 receives CRM data from the CRM integration processor 122, such as customer information, customer billing information, payment history, records of revenue from the customer, products currently used by the customer, products previously used by the customer, workflow strategies or procedures such as processes to resolve IT or technical issues, how the agent is supposed to collect customer information such as basic information, addresses, billing information, payment information, etc. The CRM data may also be meta data collected by the CRM platform 130 such as what is currently being displayed on the agent's interface or display, such as a customer information screen or interface, payment screen or interface, etc.

The audio stream 200 may be applied to a directed acyclic graph which is applied in real-time. A directed acyclic graph may be a directed graph with no directed cycles. It consists of vertices and edges (also called arcs), with each edge directed from one vertex to another, such that there is no way to start at any vertex v and follow a consistently-directed sequence of edges that eventually loops back to v again. Equivalently, a DAG is a directed graph with a topological ordering, a sequence of the vertices such that every edge is directed from earlier to later in the sequence. A directed acyclic graph may represent a network of processing elements in which data enters a processing element through its incoming edges and leaves the element through its outgoing edges. For example, the connections between the elements may be that some operations' output is the inputs of other operations. The operations can be executed as a parallel algorithm in which each operation is performed by a parallel process as soon as another set of inputs becomes available to it. The audio stream, or audio data, 200 and received CRM data may be the inputs for the ASP 202 (157), ASR 204 (156), and the call type model 210 (164).

Then the models processor 104 initiates the ASP 202 (157). The input for the ASP 202 (157) operation is the audio stream 200 received from the agent device 144. The ASP 202 (157) may be initiated as soon as the audio stream 200 is received as the input. Acoustic signal processing 202 (157) can be used to compute features that are used as input to machine learning models. A variety of acoustic measurements may be computed on moving windows/frames of the audio, using both audio channels. Acoustic measurements include pitch, energy, voice activity detection, speaking rate, turn-taking characteristics, and time-frequency spectral coefficients (e.g., Mel-frequency Cepstral Coefficients). These acoustic measurements are the features or inputs to the machine learning process. In some embodiments, this may be done in real-time or through batch processing offline. The features' output is then sent to the behavioral model 206 (109) and the call score model 214 (115).

Then the models processor 104 initiates the ASR 204 (156). The audio stream data 200 is the input, and the ASR 204 (156) may be initiated as soon as the audio stream 200 is received as the input. All of the received audio stream 200 data, or call audio, is processed using an automatic speech recognition (ASR) system 156, capable of both batch and real-time/streaming processing. Individual words or tokens may be converted from strings to numerical vectors using a pre-trained word-embeddings model that may either be developed or be publicly available, such as Word2Vec or GloVE. These word embeddings are the features or inputs to the machine learning process for modeling call phases, such as the context model 208 (111). These outputted features may be then sent to the context model 208 (111), topic detection model 212 (113), and the call score model (115) as the inputs to those operations.

The models processor 104 initiates the behavioral model 206 (109), or the behavioral model 206 (109) is initiated as soon as the data is received from the ASP 202 (157) operation. The behavioral model 206 (109) may apply a machine-learning algorithm 150 to the received features from the ASP 202 (157), such as the machine learning model created and stored in the process described herein. The features from the ASP 202 (157), such as the acoustic measurements, for example, the pitch, energy, voice activity detection, speaking rate, turn-taking characteristics, and time-frequency spectral coefficients (e.g., Mel-frequency Cepstral Coefficients). The applied machine learning model outputs a probability of a GBI, or guidable behavioral intervals such as an agent is slow to respond to a customer request, which is binarized by applying a threshold to the outputted probability.

In some embodiments, additional post-processing can be applied to facilitate a certain duration of activity before the notification is triggered, or to specify a minimum or maximum duration of activity of the notification. The notification output of the behavioral model 206 (109) is sent to be inputted into notification 216. In some embodiments, the models processor 104 may extract the behavioral model 206 machine learning model that is stored in the models database 164 and apply the extracted machine learning model to the received features from the ASP 202 (157), which outputs a probability of a GBI, or guidable behavioral intervals such as an agent are slow to respond to a customer request, so this binarized by applying a threshold to the outputted probability. In some embodiments, additional post-processing can be applied to facilitate a certain duration of activity before the notification is triggered, or to specify a minimum or maximum duration of activity of the notification.

This outputted notification is used as the input for notification 216. The models processor 104 initiates the context model 208 (111), or the context model 208 (111) is initiated as soon as the data is received from the ASR 204 (156) operation. The context model 208 may apply a machine-learning algorithm to the received features from the ASR 204, such as the machine learning model created and stored in the process described herein. The ASR 204, such as the individual words or tokens converted from strings to numerical vectors using a pre-trained word-embeddings model. The context model output is the call phase of the audio stream 200, such as the opening, information gathering, issue resolution, social, or closing. It is sent as input to notification 216. In some embodiments, the models processor (104) may extract the context model 208 machine learning model that is stored in the models database (164) and/or machine learning module (150) and apply the extracted machine learning model to the received features from the ASR 204, which outputs the call phase such as the opening, information gathering, issue resolution, social, or closing. In some embodiments, the model may output a probability of the call phase, which may be binarized by applying a threshold to the outputted probability. In some embodiments, additional post-processing can be applied to facilitate a certain duration of activity before the notification is triggered, or to specify a minimum or maximum duration of activity of the notification.

This outputted notification is used as the input for notification 216. The models processor (104) initiates the call type model 210, or the call type model 210 is initiated as soon as the data is received from the audio stream 200. The call type model 210 determines the detection of call or conversation type such as a sales call, member services, IT support, etc. This is completed using meta-data in the platform and subsequent application of a manually configurable decision tree. For example, the audio data available from the audio stream 200 may be a member of the platform or call agent on a certain team, such as sales, IT support, etc., and the call is either outbound or inbound. Simple rules may be applied to this type of metadata to determine call type. The call type output is then sent to notification 216, which is used as the input.

The models processor (104) initiates the topic detection model 212, or the topic detection model 212 is initiated as soon as the data is received from the ASR 204 operation. The topic detection model 212 may apply a machine-learning algorithm to the received features from the ASR 204, such as the machine learning model created and stored in the process described in the topic detection processor (114) and topic detection database (174). The ASR 204, such as the individual words or tokens converted from strings to numerical vectors using a pre-trained word-embeddings model. The output of the model is the call topic of the audio stream 200, such as the customer requesting supervisor escalation, the customer is likely to churn, etc., and is sent as the input to notification 216.

In some embodiments, the models processor (104) may extract the topic detection model 212 machine learning model that is stored in the models database (164) and apply the extracted machine learning model to the received features from the ASR 204, which outputs the call topic such as the customer requesting supervisor escalation, the customer is likely to churn, etc.

In some embodiments, the model may output a probability of the call topic, which may be binarized by applying a threshold to the outputted probability. In some embodiments, additional post-processing can be applied to facilitate a certain duration of activity before the notification is triggered, or to specify a minimum or maximum duration of activity of the notification. This outputted notification is used as the input for notification 216. The models processor (104) initiates the call score model 214, or the call score model 214 is initiated as soon as the data is received from the ASP 202 operation and ASR 204 operation. The call score model 214 may apply a machine-learning algorithm to the received features from the ASP 202 and the ASR 204, such as the machine learning model created and stored in the process described in the call scoring processor (116) and the call scoring database (176). The features from the ASP 202, such as involve the computation of time-frequency spectral measurements, i.e., Mel-spectral coefficients or Mel-frequency cepstral coefficients, and the data from the ASR 204, such as the individual words or tokens that are converted from strings to numerical vectors using a pre-trained word-embeddings model.

This process of acoustic signal processing, ASR processing, and transformation to an associated feature vector involving concatenation of word-embeddings and “word-aligned non-verbal embeddings” is performed incrementally, in real-time, and these measurements are used as input to the trained models which produce outputs of a call score which is sent as an input to the notification 216. In some embodiments, the models processor (104) may extract the call score model 214 machine learning model that is stored in the models database (164) and apply the extracted machine learning model to the received features from the ASP 202 and the ASR 204, which outputs the call score such as the customer experience rating or customer satisfaction rating, etc.

In some embodiments, the model may output a probability of the call score, which may be binarized by applying a threshold to the outputted probability. In some embodiments, additional post-processing can be applied to facilitate a certain duration of activity before the notification is triggered, or to specify a minimum or maximum duration of activity of the notification. This outputted notification is used as the input for notification 216.

Then the models processor (104) initiates notification 216. Notification 216 is initiated as soon as the data is received from the behavioral model 206, context model 208, call type model 210, topic detection model 212, or the call score model 214. Given the ability to detect behavioral guidance and the two dimensions of context such as call/conversation phases and types, an algorithm is configured. Specific types of behavioral guidance are only emitted, sent to the guidance integration processor (120) or CRM integration processor (122), and displayed to the user through the agent device CRM GUI (148) if the phase-type pair is switched to “on.” This phase-type grid configuration can be done by hand or can be done via automated analysis given information on top and bottom-performing call center agents. The acoustic signal processing and machine learning algorithms applied for behavioral guidance involve considerably less latency than the context model 208 or call phase detection, which depends on automatic speech recognition. This is addressed by operating on “partial” information regarding call phases when deciding whether to allow behavioral guidance or not for real-time processing. This enables the presentation of behavioral guidance as soon as it is detected, which is helpful for the targeted user experience. Post-call user experiences can show “complete” information based on what the analysis would have shown if latency was not a concern.

In some embodiments, this post-call complete information may also include a link to the CRM platform (130) to the platform (102) to listen to the audio of the call, a transcript of the call, the topics discussed during the call, etc. For example, the speech recognizer is producing real-time word outputs. It has a delay of approximately 1 to 6 seconds after the word is spoken. These words are used as input to a call phase classifier, which has roughly the same latency. The detection of behaviors, such as slow response, has much less latency. When a slow response is produced and detected, the latest call scene or phase classification is checked to determine whether or not to show the slow response. This is partial information because it is unknown what the call scene or phase classifier is for the current time point. After the call is finished, all the information is available so there can be complete measurements. Still, in real-time, decisions are based on whatever call scene data is available to that point to provide low latency guidance. If it is appropriate to send notifications to the user, then notification 216 receives the outputs of the behavioral model 206, context model 208, call type model 210, topic detection model 212, and the call score model 214 as inputs.

The output notification is sent to the guidance integration processor (120) or the CRM integration processor (122) depending on if the CRM data was incorporated or not. For example, the context-aware behavioral guidance and detected topics can be displayed in real-time to call center agents via the agent device CRM GUI (148). Events are emitted from the real-time computer system to a message queue, which the front-end application is listening on. The presence of new behavioral guidance events results in notifications appearing in the user interface, or agent's GUI (148). This data is also available for consumption by agents and their supervisors in the user experience for post-call purposes. Both call phases and behavioral guidance are presented alongside the call illustration in the user interface, such as in a PlayCallView. The data provided in the notification can be an actionable “tip” or “nudge” on how to behave, or it could be a hyper-link to some internal or external knowledge source.

FIG. 1 and FIG. 3 illustrate functioning process 300 of the topic modeling processor (shown in FIG. 1 as element 106) and topic model database (shown in FIG. 1 as element 166). The process 300 begins, as shown by 301, with topic modeling processor (106) being initiated when a predetermined period is reached, for example, at the end of the month, quarter, or year.

As shown by 302, the topic modeling processor (106) determines a time interval to collect data, such as from the previous month, week, etc. In some embodiments, a user of the platform (102) may determine the time interval.

Then, as shown by 304, the topic modeling processor (106) extracts the call audio data from the specified time interval. For example, the call audio data from the previous month. In some embodiments, the historical call audio data may be collected from the agent device (144) and stored in the historical database (192), on the platform (102).

As shown by 306, the topic modeling processor (106) performs automatic speech recognition on the call audio data from the determined time interval. For example, all call audio is processed using an automatic speech recognition (ASR) system, capable of both batch and real-time/streaming processing. Individual words or tokens are converted from strings to numerical vectors using a pre-trained word-embeddings model, which may either be developed or by using a publicly available one such as Word2Vec GloVE. These word embeddings are the features or inputs to the machine learning process for modeling call topics.

As shown by 308, the topic modeling processor (106) inputs the ASR data into the topic model algorithm. For example, the text associated with each call is treated as a “document”. This dataset of documents is used as input to a topic modeling algorithm, for example, based on Latent Dirichlet Allocation, or LDA. Latent Dirichlet Allocation may be a generative statistical model that allows sets of observations to be explained by unobserved groups that explain why some parts of the data are similar. For example, suppose observations are words collected into documents. In that case, it posits that each document is a mixture of a small number of topics and that each word's presence is attributable to one of the document's topics.

A shown by 310, human annotators review the outputted topics by the topic model algorithm. The human annotators are given a small set of calls from the particular detected topic cluster of calls and are asked to find a definition common to these examples from that cluster.

As shown by 312, the topic modeling processor (106) selects a new time interval, for example, the call audio data from the previous day. In some embodiments, a user of the platform may determine the time interval.

As shown by 314, the topic modeling processor (106) extracts the call audio data (for example, the call audio data from the previous day) from the determined time interval. In some embodiments, the historical call audio data may be collected from the agent device (144) and stored in a historical database (137) on the platform (102).

As shown by 316, the topic modeling processor (106) performs automatic speech recognition on the call audio data from the determined time interval. For example, all call audio is processed using an automatic speech recognition (ASR) system, capable of both batch and real-time/streaming processing. Individual words or tokens are converted from strings to numerical vectors using a pre-trained word-embeddings model, which may either be developed or by using a publicly available one such as Word2Vec GloVE. These word embeddings are the features or inputs to the machine learning process for modeling call topics.

As shown by 318, the topic modeling processor (106) applies the pre-trained LDA topic model, as described with respect to 308 and 310, to the ASR data. For example, the text associated with each call is treated as a “document”. This dataset of documents is used as input to a topic modeling algorithm, for example, based on Latent Dirichlet Allocation, or LDA. Latent Dirichlet Allocation may be a generative statistical model that allows sets of observations to be explained by unobserved groups that explain why some parts of the data are similar. For example, suppose observations are words collected into documents. In that case, it posits that each document is a mixture of a small number of topics and that each word's presence is attributable to one of the document's topics. Using the human annotators' definitions from step 310 allows the algorithm to provide topic labels for each call.

As shown by 320, the topic modeling processor (106) outputs the topic labels for each call in the new time interval, allowing a simple analysis of each call topic's prevalence. In some embodiments, the outputs may be sent to the Guidance integration processor (120) or the CRM data processor (132) and/or data memory (133). In some embodiments, an investigation is provided of the processing used for behavioral guidance, including speech emotion recognition, to provide a richer analysis of the topic clusters, indicating what speaking behaviors or emotion categories were most common for a particular topic.

FIG. 4 shows functioning of the behavior model processor (shown in FIG. 1 as element 110) and is described by referring back to FIG. 1. The process 400 begins, as shown by 401, with the behavior model processor (110) extracting call audio data stored in a training data database (186). The training data database (186) contains raw training call audio data that is collected from users of the platform and the call audio data may be collected from the agent device (144) and stored in the training data database (186) to be used in the machine learning processes (150) to create the models stored in the models database (164). In some embodiments, the behavior model processor (110) may be executed in a separate process to create the machine learning models (150) that are stored in the models database (164) and/or machine learning module (150) and used by the models processor (104) in real-time. In some embodiments, the training data database (186) may include the CRM data received by the CRM integration processor (122) to allow for refined or updated machine learning models that are focused on a particular customer or CRM system.

As shown by 402, the behavior model processor (110) performs acoustic signal processing on the extracted call audio data from the training data database (186). Acoustic signal processing is the electronic manipulation of acoustic signals. For example, various acoustic measurements are computed on moving windows/frames of the call audio, using both audio channels, such as the agent and the customer. Acoustic measurements include pitch, energy, voice activity detection, speaking rate, turn-taking characteristics, and time-frequency spectral coefficients (e.g., Mel-frequency Cepstral Coefficients). These acoustic measurements are used as inputs for the supervised machine learning process described with respect 408.

As shown by 404, the behavior model processor (110) extracts the data stored in a behavior training database (184), which contains labeled training data that is used by the behavior model processor (110), which uses acoustic signal processing to compute features that are used as inputs to various machine learning models, which may be performed by batch processing offline or may be performed in real-time. These computed features may be acoustic measurements, such as pitch, energy, voice activity detection, speaking rate, turn-taking characteristics, and time-frequency spectral coefficients, used as inputs during the machine learning process. In some embodiments, the behavior training database (184) may include the CRM data received by the CRM integration processor (122) to allow for refined or updated machine learning models that are focused on a particular customer or CRM system. The labeled training data contained in the behavior training database (184) provides the targets for the machine learning process. The labeled training data contained in the behavior training database (184) is created through an annotation process, in which human annotators listen to various call audio data and classify intervals of the call audio data to be guidable intervals or not. This annotation process begins with defining what behavioral guidance is to be provided to a call agent, such as a reminder for agents if they are slow to respond to a customer request. Then, candidate behavioral intervals (CBIs) are defined for the human annotators, such as intervals greater than two seconds in duration where there is no audible speaking by either party on the call. Human annotators use these definitions to listen to the call audio data and label the data when these definitions are met. There may be several iterations of refining the definitions to ensure that inter-rater reliability is sufficiently high. A large volume of authentic call data, such as the call audio data stored in the training data database 186, is labeled for CBIs by human annotators.

The next step in the annotation process is to identify the guidable behavioral intervals (GBIs), which are a subset of the CBIs classified as intervals being guidable or not. The GBIs are defined for the human annotators, and there may be several iterations of refining the definitions to ensure that inter-rater reliability is sufficiently high. Once the definitions have high inter-rater reliability, the human annotators classify all the CBIs as being guidable or not. This CBI and GBI labeled training data is stored in the behavior training database (184). The database (184) may contain the audio interval or audio clip of the CBI, the acoustic measurements such as the pitch, energy, voice activity detection, speaking rate, turn-taking characteristics, time-frequency spectral coefficients, and the GBI such as if the CBI was classified as guidable or not. In some embodiments, the database (184) may contain each call audio data with the times that a CBI occurs and whether it is guidable or not or structured in some other manner.

As shown by 406, the behavioral model processor (110) performs a supervised machine learning process using the data extracted from the training data database (186) and the behavior training database (184). For example, supervised machine learning (performed by machine learning 150, as described herein) may be the machine learning task of learning a function that maps an input to an output based on example input-output pairs. It infers a function from labeled training data consisting of a set of training examples. In supervised learning, each example is a pair consisting of an input object (typically a vector) and the desired output value (also called the supervisory signal). A supervised learning algorithm analyzes the training data and produces an inferred function, which can be used for mapping new examples.

An optimal scenario will allow for the algorithm to correctly determine the class labels for unseen instances. This helps the learning algorithm to generalize from the training data to unseen situations in a “reasonable” way. For example, the dataset of calls containing features from the training data database (186), and targets, from the behavior training database (184) is split into training, validation, and test partitions. Supervised machine learning using neural networks (152, 154) is performed to optimize weights of a particular model architecture to map features to targets, with the minimum amount of error. A variety of model architectures may be used, including stateful, for example, recurrent neural networks, or RNNs (154), and stateless, for example, convolutional neural networks, or CNNs (152); in some embodiments, a mix of the two may be used, depending on the nature of the particular behavioral guidance being targeted.

As shown by 408, the behavior model processor (110) determines the model with the highest accuracy. For example, this may be accomplished using standard binary classification metrics, including precision, recall, F1 score, and accuracy. For example, after experimenting with a large volume of model architectures and configurations, the best model is selected by evaluating accuracy metrics on the validation partition. The test partition is used simply for reporting final results to give an impression of how likely the model is to generalize well.

As shown by 410, the behavior model processor (110) stores the model with the highest determined accuracy in the models database (164).

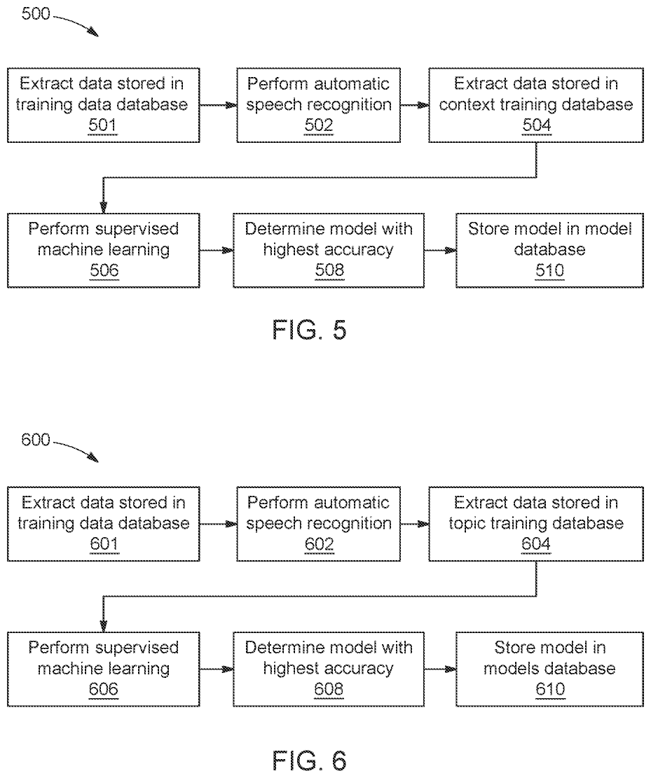

FIG. 5, illustrates an example 500 of functions of the context model processor (112) and is described referring back to FIG. 1. As shown by 501, the context model processor (112) extracting call audio data stored in training data database (186). The training data database (186) contains raw training call audio data that is collected from users of the platform and the call audio data may be collected from the agent device (144) and stored in the training data database (186) to be used in the machine learning processes to create the models stored in the models database (164). In some embodiments, the context model processor (112) may be executed in a separate process to create the machine learning models that are stored in the models database (164) and used by the models processor (104) in real-time. In some embodiments, the training data database (186) may include the CRM data received by the CRM integration processor (122) to allow for refined or updated machine learning models that are focused on a particular customer or CRM system.

As shown by 502, context model processor (112) performs automatic speech recognition on the extracted call audio data from the training data database (186). For example, all call audio is processed using an automatic speech recognition (ASR) system, capable of both batch and real-time/streaming processing. Individual words or tokens are converted from strings to numerical vectors using a pre-trained word-embeddings model, which may either be developed or by using a publicly available one such as Word2Vec GloVE. These word embeddings are the features or inputs to the machine learning process for modeling call phases.

As shown by 504, context model processor (112) extracts the data stored in context training database (187), which contains labeled training data that is used by the context model processor (112) and the context model database (172), which processes all the call audio data using an automatic speech recognition system and uses lexical- based features which are the inputs to various machine learning models, which may be performed by batch processing offline or may be performed in real-time. In some embodiments, the context training database (187) may include the CRM data received by the CRM integration processor (122) to allow for refined or updated machine learning models that are focused on a particular customer or CRM system. The labeled training data contained in the context training database (187) provides the targets for the machine learning process. The labeled training data in the context training database (186) is created through an annotation process. Human annotators listen to various call audio data and classify phases of the call audio data. This annotation process begins with defining the call phases, such as opening a call, information gathering, issue resolution, social, or closing. Human annotators use these definitions to listen to the call audio data and label the data when these definitions are met. There may be several iterations of refining the definitions to ensure that inter-rater reliability is sufficiently high. Then a large volume of authentic call data is labeled for call phases by human annotators. The call phases labeled training data is stored in the context training database (187). The database (187) may contain the audio interval or audio clip of the call topic. The call topic label includes opening a call, information gathering, issue resolution, social, or closing.

As shown by 506, context model processor (112) performs a supervised machine learning process using the data extracted from the training data database (186) and the context training database (187). For example, supervised machine learning may be the machine learning task of learning a function that maps an input to an output based on example input-output pairs. It infers a function from labeled training data consisting of a set of training examples. In supervised learning, each example is a pair consisting of an input object (typically a vector) and the desired output value (also called the supervisory signal). A supervised learning algorithm analyzes the training data and produces an inferred function, which can be used for mapping new examples. An optimal scenario will allow for the algorithm to correctly determine the class labels for unseen instances. The learning algorithm will generalize from the training data to unseen situations in a “reasonable” way. For example, the labeled data stored in the context training database (187) from the annotation process provides the machine learning process targets. The features from ASR data from the training data database (186) are used as the inputs. The dataset of calls containing features, from ASR data from the training data database (186), and targets, from the context training database (187), is split into training, validation, and test partitions. Supervised machine learning using neural networks is performed to optimize weights of a particular model architecture to map features to targets, with the minimum amount of error. A variety of stateful model architectures involving some recurrent neural network layers are used.

As shown by 510, the context model processor (112) determines the model with the highest accuracy. For example, this may be accomplished using standard binary classification metrics, including precision, recall, F1 score, and accuracy. For example, after filtering, or analyzing a large volume of model architectures and configurations, the preferred model is selected by evaluating accuracy metrics on the validation partition. The test partition is used for reporting final results to give an impression of how likely the model is to generalize well, at step 508. Then the context model processor (112) stores the model with the highest determined accuracy in the models database (164) and/or context model database (172).

FIG. 6 shows an example 600 of functions of the topic detection processor shown in FIG. 1 as element 114 and is described by referring to FIG. 1.

As shown by 601, the topic detection processor (114) extracts call audio data stored in the training data database (186). The training data database (186) contains raw training call audio data that is collected from users of the platform and the call audio data may be collected from the agent device (144) and stored in the training data database (186) to be used in the machine learning processes to create the models stored in the models database (164). In some embodiments, the topic detection processor (114) may be executed in a separate process to create the machine learning models that are stored in the models database (164) and used by the models processor (104) in real-time. In some embodiments, the training data database (186) may include the CRM data received by the CRM integration processor (122) to allow for refined or updated machine learning models that are focused on a particular customer or CRM system or CRM platform (130).

As shown by 602, the topic detection processor (114) performs automatic speech recognition on the extracted call audio data from the training data database (186). For example, all call audio is processed using an automatic speech recognition (ASR) system, capable of both batch and real-time/streaming processing. Individual words or tokens are converted from strings to numerical vectors using a pre-trained word-embeddings model, which may either be developed or by using a publicly available one such as Word2Vec GloVE. These word embeddings are the features or inputs to the machine learning process for modeling call topics.

As shown by 604, topic detection processor (114) extracts the data stored in topic training database (190), which contains labeled training data that is used by the topic detection processor (114), which processes all the call audio data using an automatic speech recognition system and uses lexical-based features that are the inputs to various machine learning models (150), which may be performed by batch processing offline or may be performed in real-time. In some embodiments, the topic training database (190) may include the CRM data received by the CRM integration processor (122) to allow for refined or updated machine learning models that are focused on a particular customer or CRM platform (130). The labeled training data contained in the topic training database (190) provides the targets for the machine learning process. The labeled training data in the topic training database (190) is created through an annotation process. Human annotators listen to various call audio data and classify topics of the call audio data.

This annotation process begins with defining the topics, such as customer requesting supervisor escalation or customer likely to churn. Human annotators use these definitions to listen to the call audio data and label the data when these definitions are met. There may be several iterations of refining the definitions to ensure that inter-rater reliability is sufficiently high. Then a large volume of authentic call data is labeled for call phases by human annotators. The call topics labeled training data is stored in the topic training database (190). The topic training database (190) may contain the audio interval or audio clip of the call topic and the call topic label such as customer requesting supervisor escalation or customer likely to churn.

As shown by 606, topic detection processor (114) performs a supervised machine learning process using the data extracted from the training data database (186) and the topic training database (190). For example, supervised machine learning may be the machine learning task of learning a function that maps an input to an output based on example input-output pairs. It infers a function from labeled training data consisting of a set of training examples. In supervised learning, each example is a pair consisting of an input object (typically a vector) and the desired output value (also called the supervisory signal). A supervised learning algorithm analyzes the training data and produces an inferred function, which can be used for mapping new examples. An optimal scenario will allow for the algorithm to correctly determine the class labels for unseen instances. The learning algorithm generalizes from the training data to unseen situations in a “reasonable” way. For example, the labeled data stored in the topic training database (190) from the annotation process provides the targets for the machine learning process, and the features from ASR data from the training data database (186) are used as the inputs. The dataset of calls containing features, from ASR data from the training data database (186), and targets, from the topic training database (190), is split into training, validation, and test partitions. Supervised machine learning using neural networks is performed to optimize weights of a particular model architecture to map features to targets, with the minimum amount of error. A variety of stateful model architectures involving some recurrent neural network layers are used.

As shown by 608, topic detection processor (114) determines the model with the highest accuracy. For example, this may be accomplished using standard binary classification metrics, including precision, recall, F1 score, and accuracy. For example, after analyzing a large volume of model architectures and configurations, the preferred model is selected by evaluating accuracy metrics on the validation partition. The test partition is used for reporting final results to give an impression of how likely the model is to generalize adequately.

As shown by 610, topic detection processor (114) stores the model with the highest accuracy in the models database (164) and/or topic detection database (174).

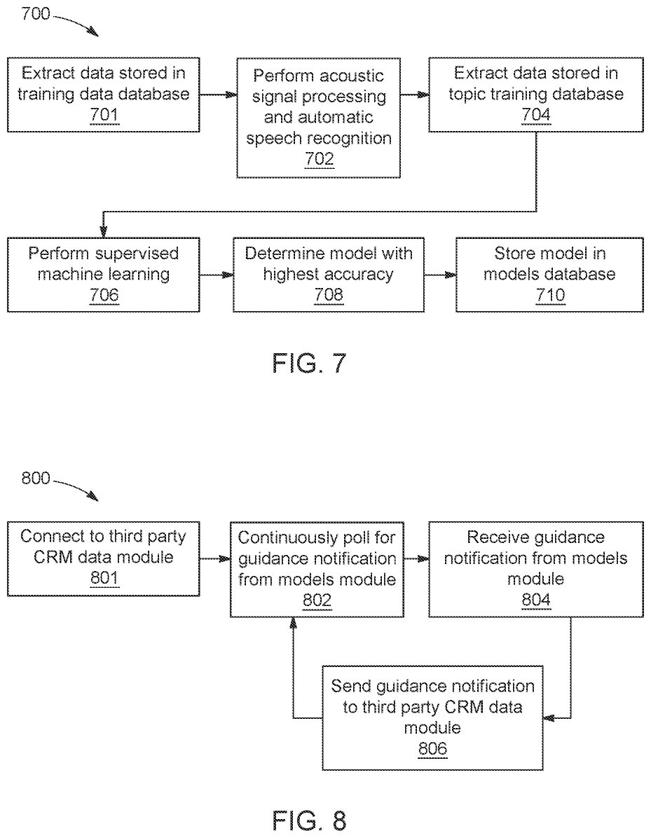

FIG. 7, described with reference to FIG. 1, illustrates an example process 700 of functioning of the call scoring processor (116) and call scoring database (176).

As shown by 701, call scoring processor (116) extracts call audio data stored in training data database (186). The training data database (186) contains raw training call audio data that is collected from users of the platform and the call audio data may be collected from the agent device (144) and stored in the training data database (186) to be used in the machine learning processes (150) to create the models stored in the models database (164). In some embodiments, the call scoring processor (116) may be executed in a separate process to create the machine learning models that are stored in the models database (164) and used by the models processor (104) in real-time. In some embodiments, the training data database (186) may include the CRM data received by the CRM integration processor (122) to allow for refined or updated machine learning models that are focused on a particular customer or CRM system or CRM platform (130).

As shown by 702, the call scoring processor (116) performs acoustic signal processing and automatic speech recognition on the extracted call audio data from the training data database (186). For example, all call audio is processed using an automatic speech recognition (ASR) system, capable of both batch and real-time/streaming processing. Individual words or tokens are converted from strings to numerical vectors using a pre-trained word-embeddings model, which may either be developed or by using a publicly available one such as Word2Vec GloVE. These word embeddings are the features or inputs to the machine learning process for modeling call scores. For example, acoustic signal processing is the electronic manipulation of acoustic signals. For example, various acoustic measurements are computed on moving windows/frames of the call audio, using both audio channels, such as the agent and the customer. Acoustic measurements include pitch, energy, voice activity detection, speaking rate, turn-taking characteristics, and time-frequency spectral coefficients (e.g., Mel-frequency Cepstral Coefficients).

As shown in 704, the call scoring processor (116) extracts the data stored in the call scoring database (176), which contains labeled training data that is used by the call scoring processor (116), which processes all the call audio data using an automatic speech recognition system and uses lexical-based features that are the inputs to various machine learning models, which may be performed by batch processing offline or may be performed in real-time. The labeled training data contained in the call scoring database (176) provides the targets for the machine learning process. In some embodiments, the call scoring database (176) may include the CRM data received by the CRM integration processor (122) to allow for refined or updated machine learning models that are focused on a particular customer or CRM system or CRM platform (130).

The labeled training data in the call scoring database (176) is created through an annotation process. Human annotators listen to various call audio data and provide a call score for the call audio data. This annotation process begins with defining the call score construct, such as the perception of customer experience or customer satisfaction. Human annotators use these definitions to listen to the call audio data and label the data when these definitions are met. There may be several iterations of refining the definitions to ensure that inter-rater reliability is sufficiently high. Then a large volume of authentic call data is labeled for call phases by human annotators. The call score labeled training data is stored in the call scoring database (176). The call scoring database (176) may contain the audio interval or audio clip of the call score. The call score label, such as the perception of customer experience or customer satisfaction.

As shown by 706, the call scoring processor (116) performs a supervised machine learning process using the data extracted from the training data database (186) and the call scoring database (176). A preliminary, unsupervised machine learning process is carried out using a substantial unlabeled call center audio data volume. In some embodiments, this unlabeled call center audio data may be audio data stored in the training data database (186). The machine learning training process involves grouping acoustic spectral measurements in the time interval of individual words, as detected by the ASR, and then mapping these spectral measurements, two-dimensional, to a one-dimensional vector representation maximizing the orthogonality of the output vector to the word-embeddings vector described above. This output may be referred to as “word-aligned, non-verbal embeddings.” The word embeddings are concatenated, with “word-aligned, non-verbal embeddings” to produce the features or inputs to the machine learning process for modeling call phases. The labeled data from the annotation process provides the targets for machine learning. The dataset of calls containing features and targets is split into training, validation, and test partitions. Supervised machine learning using neural networks is performed to optimize weights of a particular model architecture to map features to targets, with the minimum amount of error. A variety of stateful model architectures involving some recurrent neural network layers may be used.

As shown by 708, call scoring processor (116) determines the model with the highest accuracy. For example, this may be accomplished using standard binary classification metrics, including precision, recall, F1 score, and accuracy. For example, after analyzing a large volume of model architectures and configurations, the preferred model is selected by evaluating accuracy metrics on the validation partition. The test partition is used simply for reporting final results to give an impression of how likely the model is to generalize adequately.

As shown by 710, the call scoring processor (116) stores the model with the highest accuracy in a suitable memory location, such as the models database (164).

FIG. 8, described with reference to FIG. 1, illustrates an example of a process 800 of functioning of guidance integration processor, shown in FIG. 1 as element 120.

As shown by 801, the guidance integration processor (120) connects to the CRM data processor (132) and CRM data memory (133). In some embodiments, the connection may be a cloud or network connection to the CRM platform (130). In some embodiments, the connection may be able to provide the transfer of data in real-time between the platform (102) and the CRM platform (130).

As shown by 802, guidance integration processor (120) is continuously polling for the guidance notification from the models processor (104). For example, the guidance integration processor (120) may receive a guidance notification from the models processor (104) such as: the agent is slow to respond to a customer request; the call phase such as the opening, information gathering, issue resolution, social, or closing; the call type such as sales, IT support, billing, etc.; the call topic such as the customer requesting supervisor escalation, the customer is likely to churn, etc.; and/or the customer experience rating or customer satisfaction rating, etc.

As shown in 804, guidance integration processor (120) receives the guidance notification from the models processor (104) such as: the agent is slow to respond to a customer request; the call phase such as the opening, information gathering, issue resolution, social, or closing; the call type such as sales, IT support, billing, etc.; the call topic such as the customer requesting supervisor escalation, the customer is likely to churn, etc.; and/or the customer experience rating or customer satisfaction rating, etc.

As shown in 806, guidance integration processor (120) sends the guidance notification received from the models processor (104) to the CRM data processor (132) such as: the agent is slow to respond to a customer request; the call phase such as the opening, information gathering, issue resolution, social, or closing; the call type such as sales, IT support, billing, etc.; the call topic such as the customer requesting supervisor escalation, the customer is likely to churn, etc.; and/or the customer experience rating or customer satisfaction rating, etc. The guidance notification is sent to the CRM data processor (132) to be incorporated into the CRM platform (130) system and then sent to the agent device CRM GUI (148) to inform the call agent of the notification in real-time provide guidance during an interaction with a customer. In some embodiments, the guidance integration processor (120) may receive the call topic from the topic modeling processor (106) and send the call topic to the CRM data processor (132) after the completion of the call, or at a predetermined time period as discussed in the process described in the topic modeling processor (106).

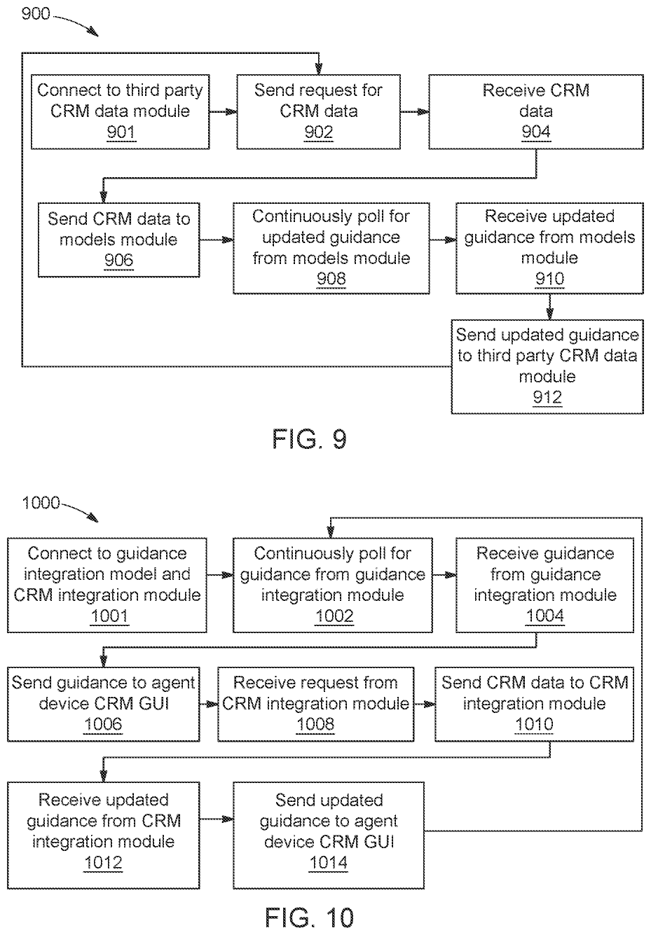

FIG. 9, described with reference to FIG. 1, illustrates an example process 900 of functioning of CRM integration processor, shown in FIG. 1 as element 122.

As shown by 901, CRM integration processor (122) connects to the CRM data processor (132). In some embodiments, the connection may be a cloud or network connection to the CRM platform (130). In some embodiments, the connection may be able to provide the transfer of data in real-time between the platform (102) and the CRM platform (130).

As shown by 902, CRM integration processor (122) sends a request to the CRM data processor (132) for the CRM data, which may be stored in CRM data memory (133). For example, the CRM data, stored in CRM data memory (133), may be the information collected by the CRM platform (130), such as customer information, customer billing information, payment history, records of revenue from the customer, products currently used by the customer, products previously used by the customer, workflow strategies or procedures such as processes to resolve IT or technical issues, how the agent is supposed to collect customer information such as basic information, addresses, billing information, payment information, etc. For example, the CRM data, stored in CRM data memory (133), may also be meta data collected by the CRM platform (130) such as what is currently being displayed on the agent's interface or display or GUI, (148), such as a customer information screen or interface, payment screen or interface, etc.

As shown by 904, CRM integration processor (122) receives the CRM data from the CRM platform (130), including CRM data processor (132) and CRM data memory (133). For example, the received CRM data may be the information collected by the CRM platform (130), such as customer information, customer billing information, payment history, records of revenue from the customer, products currently used by the customer, products previously used by the customer, workflow strategies or procedures such as processes to resolve IT or technical issues, how the agent is supposed to collect customer information such as basic information, addresses, billing information, payment information, etc. For example, the CRM data may also be meta data collected by the CRM platform (130) such as what is currently being displayed on the agent's interface or display (148), such as a customer information screen or interface, payment screen or interface, etc.

As shown by 906, CRM integration processor (122) sends the received CRM data to the models processor (104). For example, the CRM integration processor (122) sends the CRM data such as the information collected by the CRM platform (130), such as customer information, customer billing information, payment history, records of revenue from the customer, products currently used by the customer, products previously used by the customer, workflow strategies or procedures such as processes to resolve IT or technical issues, how the agent is supposed to collect customer information such as basic information, addresses, billing information, payment information, etc. For example, the CRM data may also be meta data collected by the CRM platform (130) such as what is currently being displayed on the agent's interface or display (148), such as a customer information screen or interface, payment screen or interface, etc., to the models processor (104). The data may be sent to models processor (104) to be incorporated into the process of inputting the real-time data into the machine learning algorithms, ML (150), CNN (152), RNN (154), to create more refined or updated guidance notifications to be sent to the agent device CRM GUI (148) through the CRM data processor (132). In some embodiments, the CRM data may be stored in the training data database (186) to be used in the processes described in the behavior model processor (110), context model processor (112), topic detection processor (114), and call scoring processor (116). In some embodiments, the CRM data may be stored in the behavior training database (184), context training database (187), topic training database (190), and call scoring database (176), to be used in the process described in the behavior model processor (110), context model processor (112), topic detection processor (114), and call scoring processor (116), in order to create the machine learning models that are stored in the models database (164) and used by the models processor (104) to use the real-time CRM data to provide a refined or updated guidance notification.

As shown by 908, CRM integration processor (122) then is continuously polling for the updated guidance from the models processor (104). For example, the CRM integration processor (122) is continuously polling for an updated guidance such as: the agent is slow to respond to a customer request; the call phase such as the opening, information gathering, issue resolution, social, or closing; the call type such as sales, IT support, billing, etc.; the call topic such as the customer requesting supervisor escalation, the customer is likely to churn, etc.; and/or the customer experience rating or customer satisfaction rating, etc., that incorporated the CRM data which provides the agent with a guidance notification that is more customer focused.

As shown by 910, CRM integration processor (122) receives the updated guidance from the models processor (104). For example, the CRM integration processor (122) receives the updated guidance that incorporates the CRM data such as: the agent is slow to respond to a customer request; the call phase such as the opening, information gathering, issue resolution, social, or closing; the call type such as sales, IT support, billing, etc.; the call topic such as the customer requesting supervisor escalation, the customer is likely to churn, etc.; and/or the customer experience rating or customer satisfaction rating, etc.

As shown by 912, CRM integration processor (122) sends the updated guidance to the CRM data processor (132). For example, the CRM integration processor (122) sends the updated guidance that uses the received CRM data such as: the agent is slow to respond to a customer request; the call phase such as the opening, information gathering, issue resolution, social, or closing; the call type such as sales, IT support, billing, etc.; the call topic such as the customer requesting supervisor escalation, the customer is likely to churn, etc.; and/or the customer experience rating or customer satisfaction rating, etc.

FIG. 10, described with reference to FIG. 1, illustrates an example 1000 of functioning of CRM data processor, shown in FIG. 1 as element 132.

As shown by 1001, CRM data processor (132) connects to the guidance integration processor (120) and the CRM integration processor (122).

As shown by 1002, CRM data processor (132) is continuously polling for a guidance notification from the guidance integration processor (120). For example, the CRM data processor (132) is continuously polling for the guidance notification from the guidance integration processor (120) such as: the agent is slow to respond to a customer request; the call phase such as the opening, information gathering, issue resolution, social, or closing; the call type such as sales, IT support, billing, etc.; the call topic such as the customer requesting supervisor escalation, the customer is likely to churn, etc.; and/or the customer experience rating or customer satisfaction rating, etc.

As shown by 1004 CRM data processor (132) receives the guidance notification from the guidance integration processor (120). For example, the guidance notification may be the agent is slow to respond to a customer request; the call phase such as the opening, information gathering, issue resolution, social, or closing; the call type such as sales, IT support, billing, etc.; the call topic such as the customer requesting supervisor escalation, the customer is likely to churn, etc.; and/or the customer experience rating or customer satisfaction rating, etc. In some embodiments, the data processor (132) may receive the call topics from the Guidance integration processor (120) or directly from the topic modeling processor (106).

As shown by 1006, CRM data processor (132) sends the received guidance notification to the agent device CRM GUI (148). For example, the CRM data processor 132 sends the guidance notification such as: the agent is slow to respond to a customer request; the call phase such as the opening, information gathering, issue resolution, social, or closing; the call type such as sales, IT support, billing, etc.; the call topic such as the customer requesting supervisor escalation, the customer is likely to churn, etc.; and/or the customer experience rating or customer satisfaction rating, etc. The guidance notification is then displayed on the agent device CRM GUI (148) through the system provided by the CRM platform (130) resulting in the agent being able to view the real-time guidance from the platform (102) through the system provided by the CRM platform (130) on same user interface along with the typical information provided by the CRM system such as, customer information, billing data, payment history, workflow data, etc.

As shown by 1008, CRM data processor (132) receives a request from the CRM integration processor (122) for the CRM data. For example, the CRM data may be the information collected by the CRM platform (130), such as customer information, customer billing information, payment history, records of revenue from the customer, products currently used by the customer, products previously used by the customer, workflow strategies or procedures such as processes to resolve IT or technical issues, how the agent is supposed to collect customer information such as basic information, addresses, billing information, payment information, etc. For example, the CRM data may also be meta data collected by the CRM platform (130) such as what is currently being displayed on the agent's interface or display, such as a customer information screen or interface, payment screen or interface, etc.

As shown by 1010, CRM data processor (132) sends the CRM data to the CRM integration processor (122). For example, the CRM data may be the information collected by the CRM platform (130), such as customer information, customer billing information, payment history, records of revenue from the customer, products currently used by the customer, products previously used by the customer, workflow strategies or procedures such as processes to resolve IT or technical issues, how the agent is supposed to collect customer information such as basic information, addresses, billing information, payment information, etc. For example, the CRM data may also be meta data collected by the CRM platform (130) such as what is currently being displayed on the agent's interface or display (148), such as a customer information screen or interface, payment screen or interface, etc.

As shown by 1012, CRM data processor (132) receives the update guidance notification from the CRM integration processor (122). For example, the CRM data processor (132) receives the updated guidance that incorporates the CRM data such as: the agent is slow to respond to a customer request; the call phase such as the opening, information gathering, issue resolution, social, or closing; the call type such as sales, IT support, billing, etc.; the call topic such as the customer requesting supervisor escalation, the customer is likely to churn, etc.; and/or the customer experience rating or customer satisfaction rating, etc.

As shown by 1014, CRM data processor (132) sends the updated guidance notification to the agent device CRM GUI (148). For example, the CRM data processor (132) sends the updated guidance that uses the CRM data such as: the agent is slow to respond to a customer request; the call phase such as the opening, information gathering, issue resolution, social, or closing; the call type such as sales, IT support, billing, etc.; the call topic such as the customer requesting supervisor escalation, the customer is likely to churn, etc.; and/or the customer experience rating or customer satisfaction rating, etc., to the agent device CRM GUI (148) to provide the agent currently interacting with a customer more refined or updated guidance that is focused on customer by incorporating the customer's CRM data.

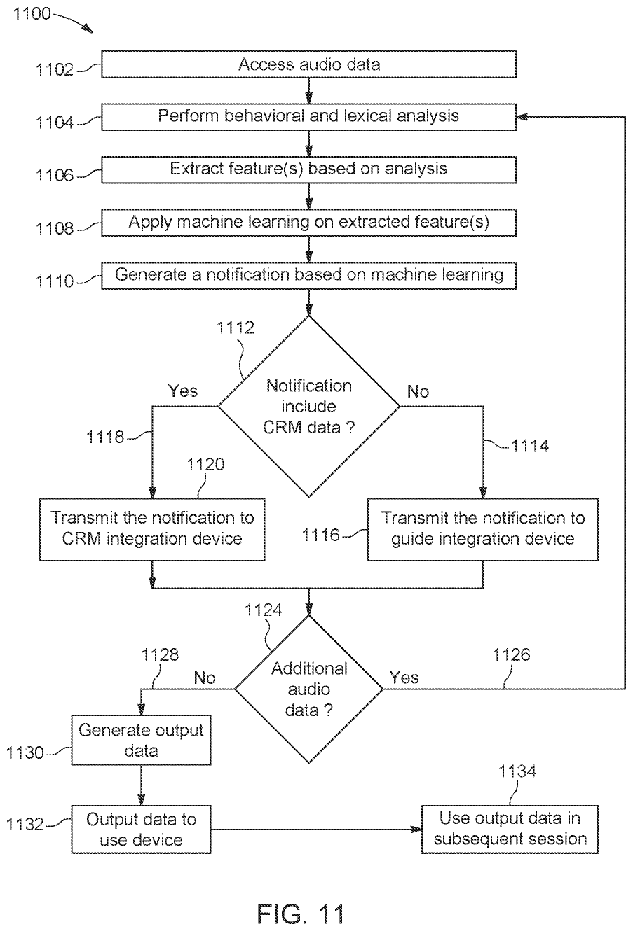

FIG. 11 illustrates a process 1100 according to an embodiment of the disclosure. This process 1100 can be a computer-implemented method for outputting feedback to a selected device, the method 1100 comprising using at least one hardware processor for extracting code for: accessing audio data, 1102. This audio data may be from a communication session, such as a caller calling a help desk, customer service line or other session. Behavioral and lexical analysis is performed on the audio data, 1104. Features are extracted, based on the behavioral and lexical analysis, 1106. Machine learning is applied to the extracted features, 1108. A notification is generated based at least in part on the machine learning, 110. A determination is made whether the notification includes CRM data, 1112. If not, “no” 1114 shows that upon determination that the notification does not include CRM data, transmitting the notification to a guidance integration device, 1116. If the notification includes CRM data, “yes” 1118 shows that, upon determination that the notification includes CRM data, transmitting the notification to a CRM integration device, 1120. A determination is made whether additional audio data is available, 1124. If so, “yes” 1126 shows that Behavioral and lexical analysis is performed on the audio data, 1104. If not, “no” 1128 shows that feedback data is generated based, at least in part, on the transmission of the notification, 1130 and outputting the feedback data to a selected device, 1132. The feedback data may be used in a subsequent communication session 1134.

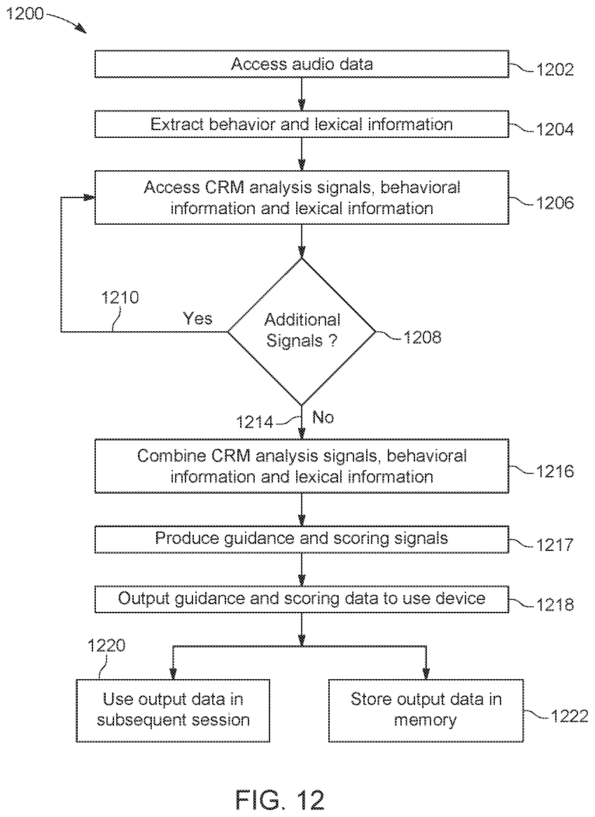

FIG. 12 illustrates a process 1200 according to an embodiment of the disclosure. The process 1200 includes accessing audio data that includes behavioral information and lexical information, 1202; extracting the behavioral information and lexical information from the audio data, 1204; accessing CRM analysis signals in real-time, 1206; determining whether there are additional signals, 1208. If so, 1210 shows the signals are accessed. If not, 1214 shows combining the CRM analysis signals, behavioral information, and lexical information to produce guidance and scoring signals, 1216; outputting the guidance and scoring signals to a user device to provide feedback related to a communication session, 1218; and the feedback may be used in a subsequent communication session, 1220 and/or storing the guidance and scoring data, 1222. The guidance and feedback can be formatted in a format associated with the CRM system.

Examples of the present disclosure:

Example 1 is directed to a computer-implemented method for outputting feedback to a selected device. The method includes accessing behavioral and lexical features determined from audio data associated with a conversation between a first party and a second party. The method also includes accessing, from a customer relationship system management (CRM) system, customer relationship management (CRM) data that includes one or more of: input from the first party, management flow data associated with the conversation, or information about the second party. Further the method includes applying the behavioral and lexical features and the CRM data to one or models that classify aspects of the conversation. The method also includes receiving, from the one or more models, one or more of guidance data or scoring data determined based at least partially on the behavioral and lexical features and the CRM data. The guidance data includes guidance for the first party in the conversation with the second party, and the scoring data includes a rating of the conversation. The method includes outputting, to the CRM system, a notification comprising the one or more of guidance data or scoring data in a format associated with the CRM system.

Example 2 is directed to a method, wherein the one or more models comprise a behavioral model, a context model, a call type model, a topic detection model, and a call score model.

Example 3 is directed to a method, wherein the one or more models are updated based on the behavioral and lexical features and the CRM data.

Example 4 is directed to a method, wherein the notification comprises one or more suggestions for interacting with the second party.

Example 5 is directed to a method further comprising determining the behavioral and lexical features from the audio data.

Example 6 is directed to a method, wherein determining the behavioral and lexical features comprises: identifying one or more parameters of the audio data; and utilizing the one or more parameters during the determination.

Example 7 is directed to a method, wherein the one or more parameters include indicators of an emotional state of the second party.

Example 8 is directed to a method, wherein the notification comprises a rating of the performance of the first party during the conversation.

Example 9 is directed to a method, wherein the notification comprises an alteration of a process flow of the CRM system.

Example 10 is directed to a method, wherein the one or more of guidance data or scoring data is utilized by the CRM system during the conversation to affect the conversation.

Example 11 is directed to a method, wherein the one or more of guidance data or scoring data is utilized by the CRM system to affect a subsequent communication session.

Example 12 is directed to a system for outputting feedback data. The system includes: a memory configured to store representations of data in an electronic form; and a processor, operatively coupled to the memory, the processor configured to access the data and process the data to: access audio data; perform behavioral and lexical analysis on the audio data; extract features based on the behavioral and lexical analysis; apply machine learning on the extracted features; generate a notification based at least in part on the machine learning; determine whether the notification includes customer relationship management (CRM) data, wherein, upon determination that the notification includes CRM data, transmitting the notification to a CRM integration device; generate feedback data based, at least in part, on the transmission of the notification; and output the feedback data to a selected device.

Example 13 is directed to the system, wherein, upon determination that the notification does not include CRM data, transmitting the notification to a guidance integration device.

Example 14 is directed to the system, further comprising outputting the feedback data to the selected device during a communication session.

Example 15 is directed to the system, further comprising identifying one or more parameters of the audio data; and utilizing one or more of the parameters during the performing behavioral and lexical analysis on the audio data.

Example 16 is directed to the system, wherein the parameters include indicators of an emotional state of a caller.

Example 17 is directed to the system, wherein the selected device is a supervisory device.

Example 18 is directed to the system, wherein the audio data is obtained from a communication session between a caller and an agent.

Example 19 is directed to a method for generating feedback. The method includes accessing audio data that includes behavioral information and lexical information; extracting the behavioral information and lexical information from the audio data; accessing CRM analysis signals in real-time; combining the CRM analysis signals, behavioral information, and lexical information to produce guidance and scoring signals; outputting the guidance and scoring signals to a user device to provide a user feedback related to a call session.

Example 20 is directed to a method, wherein the guidance and scoring signals comprises guidance for interacting with a party to the call session.

The functions performed in the processes and methods described above may be implemented in differing order. Furthermore, the outlined steps and operations are only provided as examples. Some of the steps and operations may be optional, combined into fewer steps and operations, or expanded into additional steps and operations without detracting from the disclosed embodiments' essence.

Some embodiments of the disclosure may be described as a system, method, apparatus, or computer program product. Accordingly, embodiments of the disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the disclosure may take the form of a computer program product embodied in one or more computer readable storage media, such as a non-transitory computer readable storage medium, having computer readable program code embodied thereon.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together but may comprise disparate instructions stored in different locations which, when joined logically, or operationally, together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. The system or network may include non-transitory computer readable media. Where a module or portions of a module are implemented in software, the software portions are stored on one or more computer readable storage media, which may be a non-transitory media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing, including non-transitory computer readable media.

More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray Disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals.

In the context of this disclosure, a computer readable storage medium may be any tangible medium that can contain or store a program for use by or in connection with an instruction execution system, apparatus, or device.

Program code for carrying out operations for aspects of the present disclosure may be generated by any combination of one or more programming language types, including, but not limited to any of the following: machine languages, scripted languages, interpretive languages, compiled languages, concurrent languages, list-based languages, object oriented languages, procedural languages, reflective languages, visual languages, or other language types.

The program code may execute partially or entirely on the computer (114), or partially or entirely on the surgeon's device (704). Any remote computer may be connected to the surgical apparatus (110) through any type of network (750), including a local area network (LAN) or a wide area network (WAN), or the connection may be made to an external computer (for example, through the Internet using an Internet Service Provider).

Although the following detailed description contains many specifics for the purposes of illustration, anyone of ordinary skill in the art will appreciate that many variations and alterations to the following details are within the scope of the disclosure. Accordingly, the following embodiments are set forth without any loss of generality to, and without imposing limitations upon, the claims.

In this detailed description, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present disclosure.

Furthermore, in this detailed description, a person skilled in the art should note that quantitative qualifying terms such as “generally,” “substantially,” “mostly,” “approximately” and other terms are used, in general, to mean that the referred to object, characteristic, or quality constitutes a majority of the subject of the reference. The meaning of any of these terms is dependent upon the context within which it is used, and the meaning may be expressly modified.

Some of the illustrative embodiments of the present disclosure may be advantageous in solving the problems herein described and other problems not discussed which are discoverable by a skilled artisan. While the above description contains much specificity, these should not be construed as limitations on the scope of any embodiment, but as exemplifications of the presented embodiments thereof. Many other ramifications and variations are possible within the teachings of the various embodiments. While the disclosure has been described with reference to exemplary embodiments, it will be understood by those skilled in the art that various changes may be made, and equivalents may be substituted for elements thereof without departing from the scope. In addition, many modifications may be made to adapt a particular situation or material to the teachings without departing from the essential scope thereof.

Therefore, it is intended that the disclosure not be limited to the particular embodiment disclosed as the best or only mode contemplated for carrying out this disclosure, but that the disclosure will include all embodiments falling within the scope of the appended claims. Also, in the drawings and the description, there have been disclosed exemplary embodiments and, although specific terms may have been employed, they are unless otherwise stated used in a generic and descriptive sense only and not for purposes of limitation, the scope of the disclosure therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced items. Thus, the scope of the disclosure should be determined by the appended claims and their legal equivalents, and not by the examples given.

Embodiments, as described herein can be implemented using a computing system associated with a transaction device, the computing system comprising: a non-transitory memory storing instructions; and one or more hardware processors coupled to the non-transitory memory and configured to execute the instructions to cause the computing system to perform operations. Additionally, a non-transitory machine-readable medium having stored thereon machine-readable instructions executable to cause a machine to perform operations may also be used.

It will be appreciated by those skilled in the art that changes could be made to the various aspects described above without departing from the broad inventive concept thereof. It is to be understood, therefore, that the subject application is not limited to the particular aspects disclosed, but it is intended to cover modifications within the spirit and scope of the subject disclosure as defined by the appended claims.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

I/we claim:

1. A computer-implemented method for outputting feedback to a selected device, the method comprising:
accessing behavioral and lexical features determined from audio data associated with a conversation between a first party and a second party;
accessing, from a customer relationship system management (CRM) system, customer relationship management (CRM) data that includes one or more of: input from the first party, management flow data associated with the conversation, or information about the second party;
applying the behavioral and lexical features and the CRM data to one or models that classify aspects of the conversation;
receiving, from the one or more models, one or more of guidance data or scoring data determined based at least partially on the behavioral and lexical features and the CRM data, wherein the guidance data includes guidance for the first party in the conversation with the second party, and the scoring data includes a rating of the conversation; and
outputting, to the CRM system, a notification comprising the one or more of guidance data or scoring data in a format associated with the CRM system.

2. The computer-implemented method of claim 1, wherein the one or more models comprise a behavioral model, a context model, a call type model, a topic detection model, and a call score model.

3. The computer-implemented method of claim 2, wherein the one or more models are updated based on the behavioral and lexical features and the CRM data.

4. The computer-implemented method of claim 1, wherein the notification comprises one or more suggestions for interacting with the second party.

5. The computer-implemented method of claim 1, the method further comprising determining the behavioral and lexical features from the audio data.

6. The computer-implemented method of claim 5, wherein determining the behavioral and lexical features comprises:
identifying one or more parameters of the audio data; and
utilizing the one or more parameters during the determination.

7. The computer-implemented method of claim 6, wherein the one or more parameters include indicators of an emotional state of the second party.

8. The computer-implemented method of claim 1, wherein the notification comprises a rating of the performance of the first party during the conversation.

9. The computer-implemented method of claim 1, wherein the notification comprises an alteration of a process flow of the CRM system.

10. The computer-implemented method of claim 1, wherein the one or more of guidance data or scoring data is utilized by the CRM system during the conversation to affect the conversation.

11. The computer-implemented method of claim 1, wherein the one or more of guidance data or scoring data is utilized by the CRM system to affect a subsequent communication session.

12. A system for outputting feedback data to a selected device, comprising:
a memory configured to store representations of data in an electronic form; and
a processor operatively coupled to the memory, the processor configured to access the data and process the data to:
access audio data,
perform behavioral and lexical analysis on the audio data,
extract features based on the behavioral and lexical analysis,
apply machine learning on the extracted features,
generate a notification based at least in part on the machine learning,
determine whether the notification includes customer relationship management data, wherein, upon determination that the notification includes customer relationship management data, transmit the notification to a customer relationship management integration device,
generate feedback data based, at least in part, on the transmission of the notification, and
output the feedback data to a selected device.

13. The system of claim 12, wherein, upon determination that the notification does not include customer relationship management data, transmit the notification to a guidance integration device.

14. The system of claim 12, wherein the processor is further configured to output the feedback data to the selected device during a communication session.

15. The system of claim 12, wherein the processor is further configured to:
identify one or more parameters of the audio data; and
utilize the one or more parameters during the performing behavioral and lexical analysis on the audio data.

16. The system of claim 15, wherein the parameters include indicators of an emotional state of a caller.

17. The system of claim 12, wherein the selected device is a supervisory device.

18. The system of claim 12, wherein the audio data is obtained from a communication session between a caller and an agent.

19. A method for providing feedback related to a call session comprising:
accessing audio data that includes behavioral information and lexical information;
extracting the behavioral information and lexical information from the audio data;
accessing customer relationship management analysis signals in real-time;
combining the customer relationship management analysis signals, behavioral information, and lexical information to produce guidance and scoring signals; and
outputting the guidance and scoring signals to a user device to provide a user feedback related to a call session.

20. The computer-implemented method of claim 19, wherein the guidance and scoring signals comprises guidance for interacting with a party to the call session.
